(19) United States
(12) Patent Application Publication
(10) Pub. No.: US 2018/0086338 A1
(43) Pub. Date: Mar. 29, 2018

(54) TRAVEL ASSIST DEVICE AND TRAVEL ASSIST METHOD

(71) Applicant: HONDA MOTOR CO., LTD, Tokyo (JP)

(72) Inventors: Hiroyuki Yamada, Wako-shi (JP); Makoto Katayama, Wako-shi (JP); Hiroyuki Koibuchi, Wako-shi (JP); Haruhiko Nishiguchi, Wako-shi (JP); Satoshi Fujii, Wako-shi (JP); Daiki Haratake, Wako-shi (JP); Yoshifumi Banno, Wako-shi (JP)

(21) Appl. No.: 15/705,420

(22) Filed: Sep. 15, 2017

(30) Foreign Application Priority Data
Sep. 26, 2016 (JP) 2016-186680

(51) Int. Cl. B60W 30/095; B60W 30/18; B60W 50/14

(52) U.S. Cl. CPC B60W 30/0956; B60W 30/18163; B60W 50/14; B60W 2050/146; B60W 2550/22; B60W 2720/10; B60W 2720/106; B60W 2550/308

(57) ABSTRACT

When a host vehicle makes a lane change from a first lane into a second lane, an approach suppression control unit of a travel assist device monitors whether or not another vehicle, which is traveling in a third lane existing on an opposite side from the first lane with the second lane interposed therebetween, is making a lane change into the second lane. In the case it is determined that the other vehicle is making a lane change from the third lane into the second lane, the approach suppression control unit implements an approach suppression control for suppressing the host vehicle and the other vehicle from approaching each other.

### CROSS-REFERENCE TO RELATED APPLICATION

This application is based upon and claims the benefit of priority from Japanese Patent Application No. 2016-186680 filed on Sep. 26, 2016, the contents of which are incorporated herein by reference.

### BACKGROUND OF THE INVENTION

### Field of the Invention

The present invention relates to a travel assist device and a travel assist method adapted to prevent or suppress a host vehicle and another vehicle from approaching toward each other.

### Description of the Related Art

Japanese Laid-Open Patent Publication No. 2009-262738 (hereinafter referred to as “JP 2009-262738 A”) has the object of rapidly providing a warning and issuing an alarm, in the event that another vehicle is detected behind the host vehicle in an adjacent lane lying adjacent to the travel lane of the host vehicle (see paragraph [0005], abstract). In order to realize this object, a lane departure warning device of JP 2009-262738 A (abstract) is equipped with a lane recognition unit 7b, a course estimation unit 7e, a lane departure determining unit 7f, and a first alarm buzzer 11. On the basis of a determination line, which is set so as to extend substantially in parallel with the travel lane L recognized by the lane recognition unit 7b, and a predicted course of a vehicle V as estimated by the course estimation unit 7e, the lane departure determining unit 7f determines a departure of the vehicle V from the travel lane L. The first alarm buzzer 11 issues an alarm when the lane departure determining unit 7f determines that a lane departure has occurred.

Furthermore, the lane departure warning device of JP 2009-262738 A (abstract) includes an other vehicle detection unit 7c and a determination line setting unit 7d. The other vehicle detection unit 7c detects another vehicle W in an adjacent lane M behind the vehicle V. If another vehicle W is not detected by the other vehicle detection unit 7c, the determination line setting unit 7d sets a first determination line C1 (see FIG. 3) as a determination line. Further, if another vehicle W is detected by the other vehicle detection unit 7c, the determination line setting unit 7d sets a second determination line C2 (see FIGS. 4 and 5) as a determination line.

According to JP 2009-262738 A, if another vehicle W exists in an adjacent lane M behind the vehicle V (step S1 of FIG. 6: YES→step S2: YES), and an indicated direction of the direction indicator is on the side of the adjacent lane M (step S8: YES), a second alarm buzzer is activated in order to inform the driver (step S9).

### SUMMARY OF THE INVENTION

According to JP 2009-262738 A, if another vehicle W exists in an adjacent lane M behind the vehicle V (step S1 of FIG. 6: YES→step S2: YES), and an indicated direction of the direction indicator is on the side of the adjacent lane M (step S8: YES), a second alarm buzzer is activated in order to inform the driver (step S9). Stated otherwise, according to JP 2009-262738 A, an alarm is disclosed, which is operated when the host vehicle V changes lanes, whereas the other vehicle W travels straightforward in the adjacent lane M.

According to JP 2009-262738 A, when the host vehicle V makes a lane change from the travel lane (first lane) to the adjacent lane (second lane) on a road having three or more lanes on one side, no consideration is given to a case (the case shown in FIG. 5, etc., to be described later) in which another vehicle is also attempting to make a lane change into the second lane, while traveling in a third lane on the opposite side from the first lane with the second lane interposed therebetween.

The present invention has been devised taking into consideration the aforementioned problems, and an object of the present invention is to provide a travel assist device and a travel assist method, which are capable of enhancing the merchantability of a host vehicle accompanying a lane change.

A travel assist device according to the present invention includes an approach suppression control unit configured to monitor, when a host vehicle makes a lane change from a first lane into a second lane, whether or not another vehicle, which is traveling in a third lane existing on an opposite side from the first lane with the second lane interposed therebetween, is making a lane change into the second lane, and to execute an approach suppression control to prevent the host vehicle and the other vehicle from approaching each other, in the case it is determined that the other vehicle is making a lane change from the third lane into the second lane.

According to the present invention, when the host vehicle makes a lane change from the first lane (the travel lane of the host vehicle) into the second lane (adjacent lane, target lane), approaching between the host vehicle and the other vehicle is suppressed, in the case that the other vehicle is making a lane change from the third lane (a lane existing on an opposite side from the first lane with the second lane interposed therebetween) into the second lane. In accordance with this feature, it is possible to enhance the merchantability of the host vehicle.

The travel assist device may further include a lane information acquisition unit configured to acquire position information of the second lane, an other vehicle information acquisition unit configured to acquire position information of the other vehicle, and an approach suppression operation unit configured to perform an approach suppression operation to prevent the host vehicle and the other vehicle from approaching each other based on a command from the approach suppression control unit. The approach suppression operation unit may include at least one of a notifying unit configured to notify a vehicle occupant of the presence of the other vehicle, and a behavior control unit configured to control the behavior of the host vehicle, and thereby prevent the host vehicle and the other vehicle from approaching each other. The approach suppression control unit may set an operation target range configured to be used for carrying out the approach suppression operation by the approach suppression operation unit, based on the position information of the host vehicle and the position information of the second lane. Further, the approach suppression control unit may cause the approach suppression operation to be carried out by the approach suppression operation unit, in the case it is determined that the other vehicle has entered into the operation target range, or in the case it is estimated that the other vehicle will enter into the operation target range.

According to the above description, the approach suppression operation is carried out in the case it is determined that the other vehicle has entered into the operation target range, or in the case it is estimated that the other vehicle will enter into the operation target range. Stated otherwise, the approach suppression operation is not carried out in the case it is determined that the other vehicle, while traveling in the third lane, has not entered into the operation target range, or in the case it is not estimated that the other vehicle will enter into the operation target range. In accordance with this feature, it is possible to enhance the merchantability of the host vehicle, by selecting the other vehicle that has influence on a lane change of the host vehicle, and performing the approach suppression operation.

When, among two lane markings that define the second lane, a lane marking on a side of the first lane is defined as a near side lane marking, and a lane marking on a side of the third lane is defined as a far side lane marking, the lane information acquisition unit may acquire width information of the second lane indicative of the distance between the near side lane marking and the far side lane marking, or may acquire position information of the far side lane marking. In addition, the approach suppression control unit may set the operation target range based on the width information of the second lane, or the position information of the far side lane marking.

In accordance with this feature, by setting the operation target range on the basis of the width information of the second lane (adjacent lane, target lane), or the position information of the far side lane marking, it is possible to appropriately grasp the positional relationship between the host vehicle, which is making a lane change into the second lane, and the other vehicle.

The approach suppression control unit may set the operation target range to a lateral side of the host vehicle. In accordance with this feature, it is possible to more appropriately grasp the positional relationship between the other vehicle and the lateral side of the host vehicle.

The approach suppression control unit may set as the operation target range a range between a lateral side of the host vehicle and the far side lane marking. In accordance with this feature, it is possible to more appropriately grasp the positional relationship between the other vehicle and the lateral side of the host vehicle.

The approach suppression control unit may treat as a monitoring target the other vehicle, which exhibits a behavior of making a lane change into the second lane, and may determine a positional relationship thereof with the operation target range. In accordance with this feature, positional relationships are not determined between all of the other vehicles traveling in the third lane and the operation target range, but rather, only the positional relationship with the operation target range of the other vehicle, which exhibits a behavior of approaching the second lane, is determined. Consequently, it is possible to reduce the computational load associated with determining the positional relationship between the other vehicle and the operation target range. Along therewith, a configuration is facilitated in which determination of the positional relationship can be carried out with high accuracy.

The travel assist device may further include a host vehicle information acquisition unit configured to acquire position information of the host vehicle. If the current position of the host vehicle reaches a reference position in a widthwise direction of the second lane, the approach suppression control unit may limit suppression of the approach. In accordance with this feature, when the current position of the host vehicle reaches the reference position, suppression of the approach between the host vehicle and the other vehicle (notification of the existence of the other vehicle, behavior control of the host vehicle to suppress the approach, etc.) is not carried out. Consequently, for example, in a state in which the lane change has already been substantially completed, it is possible to avoid or reduce a feeling of unease or discomfort of the vehicle occupant accompanying suppression of the approach between the host vehicle and the other vehicle.

The travel assist device may further include a camera configured to capture an image of a front or rear of the host vehicle. The approach suppression control unit may extract one portion of the far side lane marking from the image information from the camera. Further, the approach suppression control unit may calculate another portion of the far side lane marking, which is not included within the image information, on the basis of the position of the one portion of the far side lane marking included within the image information. Furthermore, the approach suppression control unit may determine whether or not the other vehicle is making a lane change into the second lane on the basis of the calculated position of the other portion of the far side lane marking, and the position of the other vehicle.

In accordance with this feature, it is possible to determine whether or not the other vehicle is making a lane change into the second lane, even if the far side lane marking of the second lane in the vicinity of the other vehicle is not included within the field angle (angle of view) of the camera.

The approach suppression control unit may include a first trajectory acquisition unit configured to acquire a predicted trajectory of the host vehicle, and a second trajectory acquisition unit configured to acquire a predicted trajectory of the other vehicle. Furthermore, in the case it is determined on the basis of the predicted trajectories of the host vehicle and the other vehicle that the host vehicle and the other vehicle come into a predetermined state of approach, the approach suppression control unit may suppress the approach between the host vehicle and the other vehicle. In accordance with this feature, using the predicted trajectories of the host vehicle and the other vehicle, it is possible to highly accurately determine whether it is necessary or unnecessary to suppress the approach between the host vehicle and the other vehicle.

In the case that another fourth lane exists between the second lane and the third lane, the approach suppression control unit may limit suppression of the approach. Owing to this feature, for example, in accordance with the predicted trajectory of the other vehicle, even if there is a possibility of determining that the other vehicle is making a lane change into the second lane, if the other vehicle makes a lane change into the fourth lane instead of the second lane, it is possible to avoid or suppress excessive execution of the approach suppression control. Accordingly, it is possible to prevent the driver from experiencing a sense of discomfort accompanying an excessive approach suppression control.

The travel assist device may further include an acceleration/deceleration assist unit configured to automatically accelerate or decelerate the host vehicle by setting a target vehicle velocity or a target acceleration/deceleration. In the approach suppression control, mutual approaching between the host vehicle and the other vehicle may be suppressed by changing the target vehicle velocity or the target acceleration/deceleration by the acceleration/deceleration assist unit. In accordance with this feature, it becomes easy to prevent the host vehicle and the other vehicle from approaching each other.

In the case it is estimated that the other vehicle will complete making a lane change into the second lane earlier than the host vehicle, or in the case that the entrance distance of the other vehicle into the second lane is greater than that of the host vehicle, the approach suppression control unit may execute the approach suppression control so as to delay entry of the host vehicle with respect to the second lane. In accordance with this feature, it becomes easy to prevent the host vehicle and the other vehicle from approaching each other.

In the case it is estimated that the host vehicle will complete making a lane change into the second lane earlier than the other vehicle, or in the case that the entrance distance of the host vehicle into the second lane is greater than that of the other vehicle, the approach suppression control unit may execute the approach suppression control so as to hasten entry of the host vehicle with respect to the second lane, or may limit the approach suppression control. In the case that the approach suppression control is executed so as to hasten entry of the host vehicle with respect to the second lane, it becomes easy to further prevent the host vehicle and the other vehicle from approaching each other. Further, in the case of limiting suppression of the approach between the host vehicle and the other vehicle (notification of the existence of the other vehicle, behavior control of the host vehicle to suppress the approach, etc.), for example, it is possible to avoid or reduce a feeling of unease or discomfort of the vehicle occupant accompanying excessive suppression of the approach between the host vehicle and the other vehicle.

A travel assist method according to the present invention includes the steps of, when a host vehicle makes a lane change from a first lane into a second lane, determining with an approach suppression control unit whether or not another vehicle, which is traveling in a third lane existing on an opposite side from the first lane with the second lane interposed therebetween, is making a lane change into the second lane, and executing, with the approach suppression control unit, an approach suppression control to prevent the host vehicle and the other vehicle from approaching each other, in the case it is determined that the other vehicle is making a lane change from the third lane into the second lane.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing a configuration of a vehicle (hereinafter referred to as a “host vehicle”) including a travel assist device according to an embodiment of the present invention;

FIG. 2 is a diagram showing an imaging range of vehicle exterior cameras, and a detection range of radar devices in the present embodiment;

FIG. 3 is a block diagram showing functions realized by a computation unit of the travel electronic control unit (hereinafter referred to as a “travel ECU”) of the present embodiment;

FIG. 4 is a flowchart of a third lane target control in the present embodiment;

FIG. 5 is an explanatory diagram for describing a method of detecting respective lanes in the present embodiment;

FIG. 6 is an explanatory diagram for describing a state, according to the present embodiment, in which the travel ECU of the host vehicle recognizes a lane change made by another vehicle;

FIG. 7 is a flowchart (details of step S15 of FIG. 4) for determining a possibility of contact between the host vehicle and the other vehicle in the present embodiment;

FIG. 8A is a diagram showing a first example of a positional relationship between the host vehicle and the other vehicle, for the purpose of determining the possibility of contact in the present embodiment;

FIG. 8B is a view showing a travel trajectory of the host vehicle and the other vehicle up to the point P21 in FIG. 8A, and a predicted trajectory of the host vehicle and the other vehicle at the point P21;

FIG. 9A is a diagram showing a second example of a positional relationship between the host vehicle and the other vehicle, for the purpose of determining the possibility of contact in the present embodiment;

FIG. 9B is a view showing a travel trajectory of the host vehicle and the other vehicle up to the point P31 in FIG. 9A, and a predicted trajectory of the host vehicle and the other vehicle at the point P31;

FIG. 10 is an explanatory diagram showing a first pattern in relation to a method of calculating an operation target range that can be used in the present embodiment;

FIG. 11 is an explanatory diagram showing a second pattern in relation to a method of calculating an operation target range that can be used in the present embodiment;

FIG. 12 is an explanatory diagram showing a third pattern in relation to a method of calculating an operation target range that can be used in the present embodiment;

FIG. 13 is an explanatory diagram showing a fourth pattern in relation to a method of calculating an operation target range that can be used in the present embodiment;

FIG. 14 is an explanatory diagram showing a fifth pattern in relation to a method of calculating an operation target range that can be used in the present embodiment;

FIG. 15 is a flowchart of an approach suppression control of the present embodiment;

FIG. 16 is a first explanatory diagram for describing the approach suppression control of the present embodiment;

FIG. 17 is a second explanatory diagram for describing the approach suppression control of the present embodiment;

FIG. 18 is a third explanatory diagram for describing the approach suppression control of the present embodiment;

FIG. 19 is a flowchart of an approach suppression control according to a modified example;

FIG. 20A is a diagram showing positions of the host vehicle and the other vehicle at a certain point in time, as well as positions of the host vehicle and the other vehicle estimated at that point in time;

FIG. 20B is a diagram showing positions of the host vehicle and the other vehicle at that point in time, as well as positions of the host vehicle and the other vehicle as a result of causing the host vehicle to accelerate by the approach suppression control according to the modified example;

FIG. 21A is a diagram showing positions of the host vehicle and the other vehicle at a certain point in time, as well as positions of the host vehicle and the other vehicle estimated at that point in time; and

FIG. 21B is a diagram showing positions of the host vehicle and the other vehicle at that point in time, as well as positions of the host vehicle and the other vehicle as a result of causing the host vehicle to decelerate by the approach suppression control according to the modified example.

### DESCRIPTION OF THE PREFERRED EMBODIMENTS

### A. Embodiment

### <A-1. Configuration>

### [A-1-1. Overall Configuration]

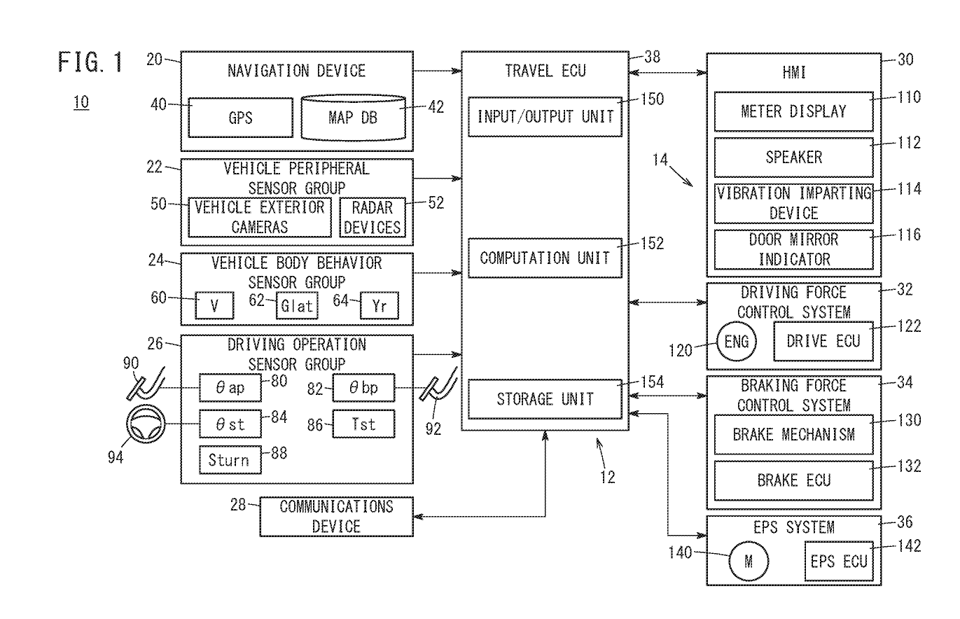

FIG. 1 is a block diagram showing the configuration of a vehicle 10 including a travel assist device 12 according to an embodiment of the present invention. The vehicle 10 (hereinafter also referred to as a “host vehicle 10”) includes a navigation device 20, a vehicle peripheral sensor group 22, a vehicle body behavior sensor group 24, a driving operation sensor group 26, a communications device 28, a human-machine interface 30 (hereinafter referred to as an “HMI 30”), a driving force control system 32, a braking force control system 34, an electric power steering system 36 (hereinafter referred to as an “EPS system 36”), and a travel electronic control unit 38 (hereinafter referred to as a “travel ECU 38” or an “ECU 38”).

The travel assist device 12 includes the HMI 30, the driving force control system 32, the braking force control system 34, the EPS system 36, and the ECU 38. Further, the HMI 30, the driving force control system 32, the braking force control system 34, and the EPS system 36 collectively constitute an approach suppression operation unit 14. The approach suppression operation unit 14 performs an approach suppression operation to prevent or suppress the host vehicle 10 and another vehicle 500 from approaching each other, on the basis of a command from the ECU 38 (approach suppression control unit).

### [A-1-2. Navigation Device 20]

The navigation device 20 performs route guidance along a planned route Rv of the host vehicle 10 to a target destination point Pgoal. The navigation device 20 includes a global positioning system sensor 40 (hereinafter referred to as a “GPS sensor 40”), and a map database 42 (hereinafter referred to as a “map DB 42”). The GPS sensor 40 detects the current position Pgps of the vehicle 10. Road map information (map information Imap) is stored in the map DB 42.

### [A-1-3. Vehicle Peripheral Sensor Group 22]

The vehicle peripheral sensor group 22 detects information (hereinafter also referred to as “vehicle peripheral information Ic”) in relation to the periphery of the host vehicle 10. The vehicle peripheral sensor group 22 includes a plurality of vehicle exterior cameras 50 and a plurality of radar devices 52.

The vehicle exterior cameras 50 (hereinafter also referred to as “cameras 50”) in the present embodiment output image information Iimage obtained by capturing images of the periphery (front and rear) of the vehicle 10. As the vehicle exterior cameras 50, there may also be provided cameras for imaging the sides (at least one of a left side and a right side) of the host vehicle 10. The plurality of radar devices 52 output radar information Iradar indicative of reflected waves with respect to electromagnetic waves transmitted around the periphery (a left lateral side and a right lateral side) of the vehicle 10. The vehicle exterior cameras 50 and the radar devices 52 serve as periphery recognition devices that recognize the vehicle peripheral information Ic.

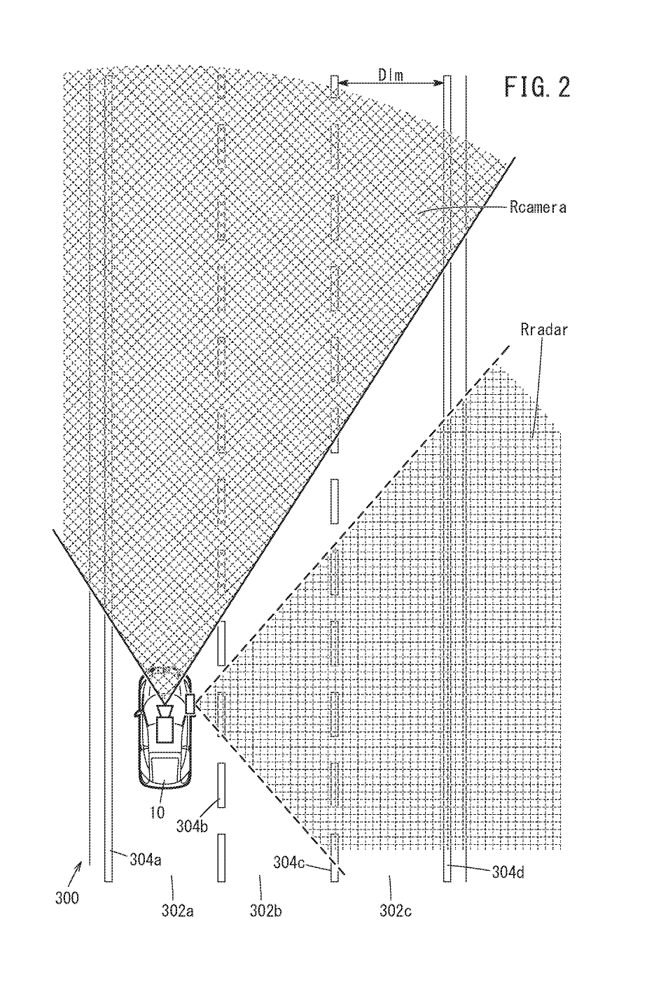

FIG. 2 is a diagram showing an imaging range Rcamera of the vehicle exterior cameras 50, and a detection range Rradar of the radar devices 52 in the present embodiment. As shown in FIG. 2, the imaging range Rcamera is shown only in front of the vehicle 10, however, a similar imaging range Rcamera is also set behind the vehicle 10. Further, in FIG. 2, the detection range Rradar is shown only on the right side of the vehicle 10, however, a similar detection range Rradar is also set on the left side of the vehicle 10. Moreover, in FIG. 2, in order to facilitate understanding, the imaging range Rcamera and the detection range Rradar do not overlap with each other. However, in actuality, the imaging range Rcamera and the detection range Rradar are set so as to overlap with each other.

In FIG. 2, three lanes 302a, 302b, and 302c are shown as existing on one side of a road 300 on which the host vehicle 10 travels. The first lane 302a is defined by the lane markings 304a and 304b. The second lane 302b is defined by the lane markings 304b and 304c. The third lane 302c is defined by the lane markings 304c and 304d.

Hereinbelow, the lanes 302a, 302b, 302c, etc., as shown in FIG. 2, etc., are referred to collectively as lanes LN. Further, the lane markings 304a, 304b, 304c, 304d, etc., as shown in FIG. 2, etc., are referred to collectively as lane markings LM.

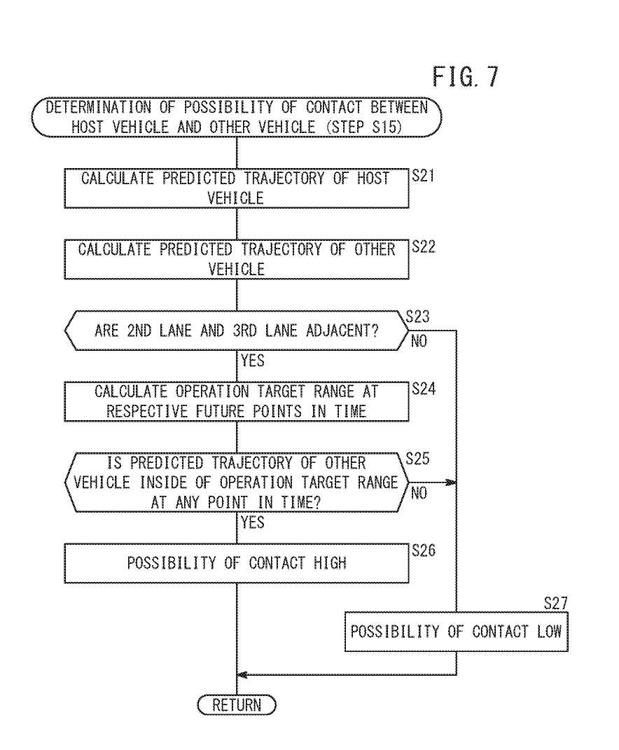

Further, a travel lane (for example, the lane 302a in FIG. 2) in which the host vehicle 10 travels is referred to as a first lane LN1 or a travel lane LN1. An adjacent lane lying adjacent to the first lane LN1 (for example, the lane 302b in FIG. 2) is referred to as a second lane LN2 or an adjacent lane LN2. A lane (for example, the lane 302c in FIG. 2), which exists on an opposite side of the second lane LN2 from the first lane LN1, and has the same travel direction as that of the first lane LN1 and the second lane LN2, is referred to as a third lane LN3. Moreover, in the case that another fourth lane LN4 exists having the same travel direction as that of the first to third lanes LN1 to LN3, the third lane LN3 is, in a certain case, defined as a lane LN in which another vehicle 500 is traveling, which travels in the same direction as the host vehicle 10 (step S23 in FIG. 7).

### [A-1-4. Vehicle Body Behavior Sensor Group 24]

The vehicle body behavior sensor group 24 detects information (hereinafter also referred to as “vehicle body behavior information Ib”) in relation to the behavior of the vehicle 10 (in particular, the vehicle body). The vehicle body behavior sensor group 24 includes a vehicle velocity sensor 60, a lateral acceleration sensor 62, and a yaw rate sensor 64.

The vehicle velocity sensor 60 detects the vehicle velocity V [km/h] of the vehicle 10. The lateral acceleration sensor 62 detects the lateral acceleration Glat [m/s/s] of the vehicle 10. The yaw rate sensor 64 detects the yaw rate Yr [rad/s] of the vehicle 10.

### [A-1-5. Driving Operation Sensor Group 26]

The driving operation sensor group 26 detects information (hereinafter also referred to as “driving operation information Io”) in relation to driving operations performed by the driver. In the driving operation sensor group 26, there are included an accelerator pedal sensor 80, a brake pedal sensor 82, a steering angle sensor 84, a steering torque sensor 86, and a blinker switch 88.

The accelerator pedal sensor 80 (hereinafter also referred to as an “AP sensor 80”) detects an operation amount θap (hereinafter also referred to as an “AP operation amount θap”) [%] of an accelerator pedal 90. The brake pedal sensor 82 (hereinafter also referred to as a “BP sensor 82”) detects an operation amount θbp (hereinafter also referred to as a “BP operation amount θbp”) [%] of a brake pedal 92. The steering angle sensor 84 detects a steering angle θst (hereinafter also referred to as an “operation amount θst”) [deg] of a steering wheel 94. The steering torque sensor 86 detects a steering torque Tst [N·m] applied to the steering wheel 94.

The blinker switch 88 is a switch for causing blinker lamps (not shown) to blink, for thereby providing a notification to the periphery of the host vehicle 10 that the host vehicle 10 is making a turn (a right turn or a left turn). The blinker switch 88 outputs a signal Sturn (hereinafter also referred to as a “turn signal Sturn”) indicating the selected state of the blinker switch 88.

### [A-1-6. Communications Device 28]

The communications device 28 performs wireless communications with an external device. In this instance, the external device may include, for example, a non-illustrated external server. The external server may include, instead of the navigation device 20, a route guidance server for calculating in detail a planned route Rv, and a traffic information server for providing traffic information to the vehicle 10.

Moreover, although it is assumed that the communications device 28 of the present embodiment is mounted (or fixed at all times) in the vehicle 10, the communications device 28 may be, for example, a device that can be carried to locations outside of the vehicle 10, such as a mobile phone or a smart phone.

### [A-1-7. HMI 30]

The HMI 30 accepts operations input from a vehicle occupant (including the driver), together with presenting various information to the vehicle occupant visually, audibly, and tactilely. In the HMI 30, there are included a meter display 110, a speaker 112, a vibration imparting device 114, and a door mirror indicator 116. The blinker switch 88, the accelerator pedal 90, the brake pedal 92, and the steering wheel 94 may be positioned as portions of the HMI 30.

The meter display 110 is a display device provided on a non-illustrated instrument panel. The meter display 110 includes, for example, a liquid crystal panel or an organic EL panel. The meter display 110 may be configured as a touch panel.

The speaker 112 outputs, by way of sound, a notification with respect to a vehicle occupant (including the driver), which is performed by the travel assist device 12. In the case that the speaker 112 is provided on a rear part or a side part (door panel) of the vehicle 10, the notification sound may be output from the rear part or the side part of the host vehicle 10. In accordance with this feature, it becomes easier for the driver to perceive the notification sound. The vibration imparting device 114 is provided inside of a lumbar support section (not shown) of the driver's seat, and on the basis of a command from the travel ECU 38, imparts vibrations to the driver. Instead of such vibrations (periodic displacement), it also is possible to inflate or otherwise cause the driver's seat to expand. Further, a plurality of the vibration imparting devices 114 may be provided on left and right sides of the driver's seat, and may also be used to provide a notification of the direction of approach of the other vehicle 500. The door mirror indicator 116 is a light emitting unit disposed around the periphery of a non-illustrated door mirror.

### [A-1-8. Driving Force Control System 32]

The driving force control system 32 includes an engine 120 (drive source) and a drive electronic control unit 122 (hereinafter referred to as a “drive ECU 122”). The aforementioned AP sensor 80 and the accelerator pedal 90 may also be positioned as components of the driving force control system 32. The drive ECU 122 executes a driving force control for the vehicle 10 using the AP operation amount θap, etc. When the driving force control is implemented, the drive ECU 122 controls a travel driving force Fd of the vehicle 10 through the control of the engine 120.

### [A-1-9. Braking Force Control System 34]

The braking force control system 34 includes a brake mechanism 130 and a brake electronic control unit 132 (hereinafter referred to as a “brake ECU 132”). The aforementioned BP sensor 82 and the brake pedal 92 may also be positioned as components of the braking force control system 34. The brake mechanism 130 actuates a brake member by a brake motor (or a hydraulic mechanism) or the like.

The brake ECU 132 executes a braking force control for the vehicle 10 using the BP operation amount θbp, etc. When the braking force control is implemented, the brake ECU 132 controls the braking force Fb of the vehicle 10 through the control of the brake mechanism 130, etc.

### [A-1-10. EPS System 36]

The EPS system 36 includes an EPS motor 140 and an EPS electronic control unit 142 (hereinafter referred to as an “EPS ECU 142” or an “ECU 142”). The aforementioned steering angle sensor 84, the steering torque sensor 86, and the steering wheel 94 may also be positioned as components of the EPS system 36.

The EPS ECU 142 controls the EPS motor 140 according to commands from the travel ECU 38, and thereby controls a turning amount R of the vehicle 10. In the turning amount R, there are included the steering angle θst, the lateral acceleration Glat, and the yaw rate Yr.

### [A-1-11. Travel ECU 38]

### (A-1-11-1. Outline of Travel ECU 38)

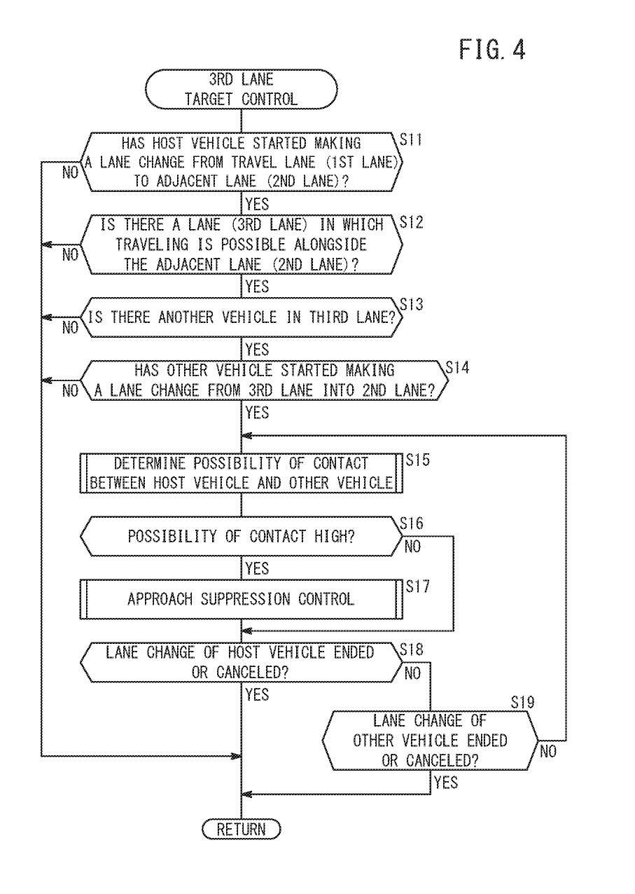

The travel ECU 38 is a computer that executes the various controls (travel controls) in relation to traveling of the vehicle 10, and includes a central processing unit (CPU). Among the travel controls, there are included a lane change assist control for assisting a lane change in accordance with steering by the driver using the steering wheel 94. Details of the lane change assist control will be described later with reference to FIG. 4, etc.

As shown in FIG. 1, the ECU 38 includes an input/output unit 150, a computation unit 152, and a storage unit 154. Moreover, portions of the functions of the travel ECU 38 can be borne by an external device existing externally of the vehicle 10.

### (A-1-11-2. Input/Output Unit 150)

The input/output unit 150 performs input and output operations with respect to devices apart from the ECU 38 (the navigation device 20, the sensor groups 22, 24, 26, the communications device 28, etc.). The input/output unit 150 includes a non-illustrated A/D conversion circuit that converts input analog signals into digital signals.

### (A-1-11-3. Computation Unit 152)

The computation unit 152 carries out calculations based on signals received from the navigation device 20, the respective sensor groups 22, 24, 26, the communications device 28, the HMI 30, and the ECUs 122, 132, 142, etc. In addition, based on the calculation results thereof, the computation unit 152 generates and outputs signals with respect to the navigation device 20, the communications device 28, the drive ECU 122, the brake ECU 132, and the EPS ECU 142.

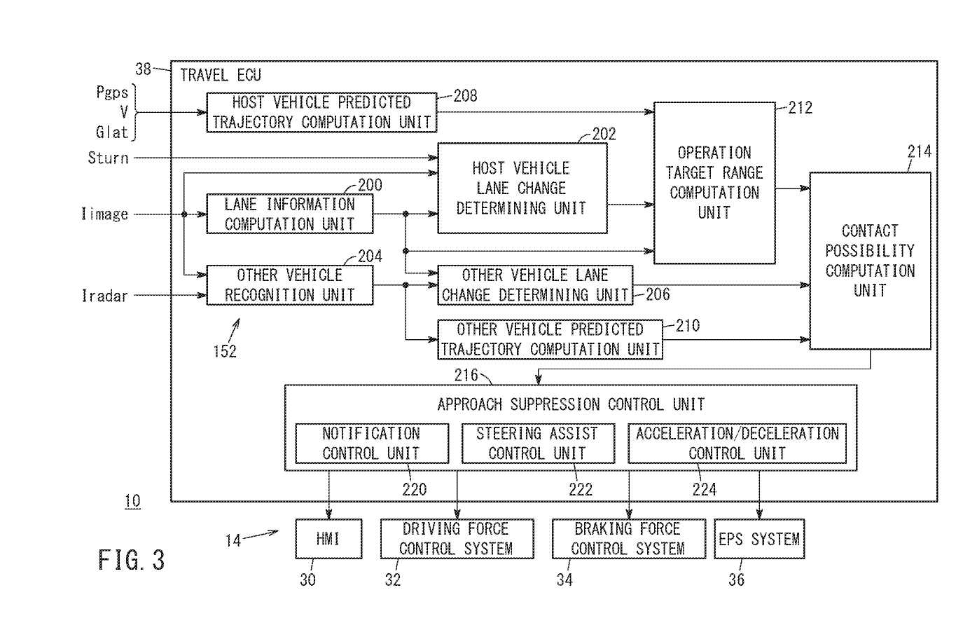

FIG. 3 is a block diagram showing functions realized by the computation unit 152 of the travel ECU 38 according to the present embodiment. As shown in FIG. 3, the computation unit 152 of the travel ECU 38 includes a lane information computation unit 200, a host vehicle lane change determining unit 202, an other vehicle recognition unit 204, an other vehicle lane change determining unit 206, a host vehicle predicted trajectory computation unit 208, an other vehicle predicted trajectory computation unit 210, an operation target range computation unit 212, a contact possibility computation unit 214, and an approach suppression control unit 216. These respective components are realized by executing a program stored in the storage unit 154. The program may be supplied from an external device via the communications device 28. Portions of the program may also be constituted by hardware (circuit components). Moreover, the inputs to the ECU 38 shown in FIG. 3 are examples of such inputs, and other inputs are also possible (details thereof will be described later).

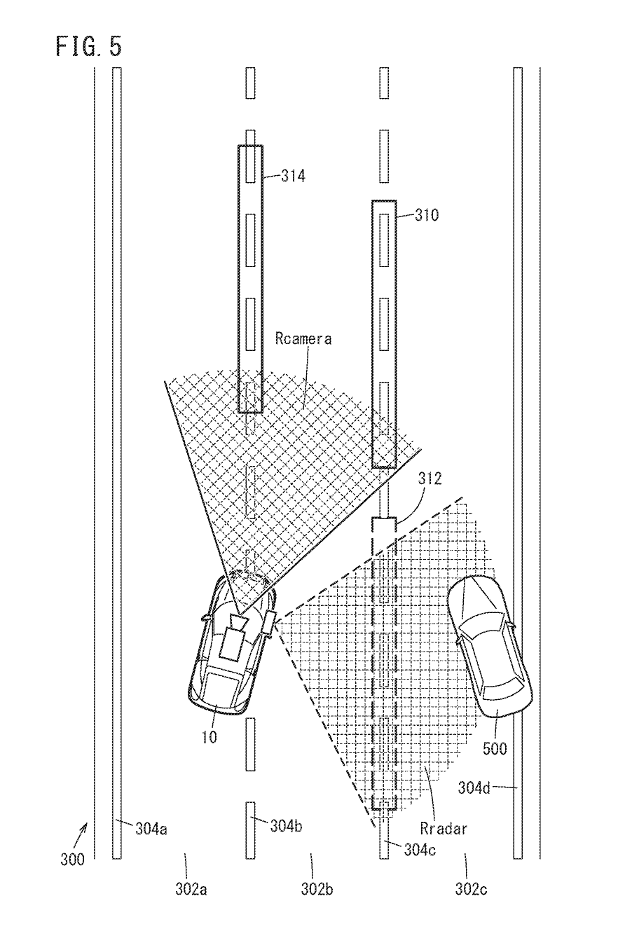

The lane information computation unit 200 recognizes the lane markings LM (lane markings 304a, 304b, 304c, 304d of FIG. 2, etc.) on the basis of the image information Iimage from the cameras 50. In addition, the lane information computation unit 200 recognizes the lanes LN (lanes 302a, 302b, 302c of FIG. 5, etc.) on the basis of the recognized lane markings LM. In addition, the recognized lanes LN and lane markings LM are output, as information Ilane (hereinafter also referred to as “lane information Ilane”) in relation to the lane markings LM and the lanes LN, to the host vehicle lane change determining unit 202, and the other vehicle lane change determining unit 206.

The host vehicle lane change determining unit 202 determines the start, the end, and cancellation of a lane change of the host vehicle 10, and outputs host vehicle lane change information Ilchv. The other vehicle recognition unit 204 recognizes another vehicle 500 on the basis of the radar information Iradar from the radar devices 52, and the image information Iimage from the cameras 50, and outputs position information Ipov indicative of the position Pov of the other vehicle 500. The other vehicle lane change determining unit 206 determines the start, the end, and cancellation of a lane change of the other vehicle 500, and outputs other vehicle lane change information Ilcov.

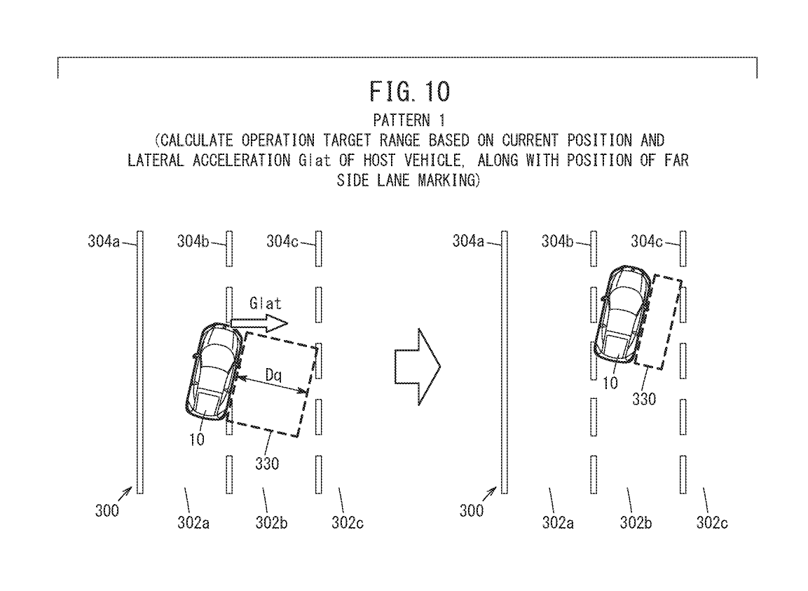

The host vehicle predicted trajectory computation unit 208 calculates a predicted trajectory Lhve of the host vehicle 10, on the basis of the current position Pgps, the vehicle velocity V, and the lateral acceleration Glat of the host vehicle 10. The other vehicle predicted trajectory computation unit 210 calculates a predicted trajectory Love of the other vehicle 500 on the basis of the position information Ipov of the other vehicle 500. The operation target range computation unit 212 calculates an operation target range 330 (see FIG. 10 to FIG. 14, etc.) for the purpose of determining the necessity of an approach suppression control, to be described later. The contact possibility computation unit 214 calculates a possibility of contact Pc between the host vehicle 10 and the other vehicle 500, on the basis of the other vehicle lane change information Ilcov, the other vehicle predicted trajectory Love, and the operation target range 330.

The approach suppression control unit 216 executes the approach suppression control on the basis of the contact possibility Pc, etc. As shown in FIG. 3, the approach suppression control unit 216 includes a notification control unit 220, a steering assist control unit 222, and an acceleration/deceleration control unit 224.

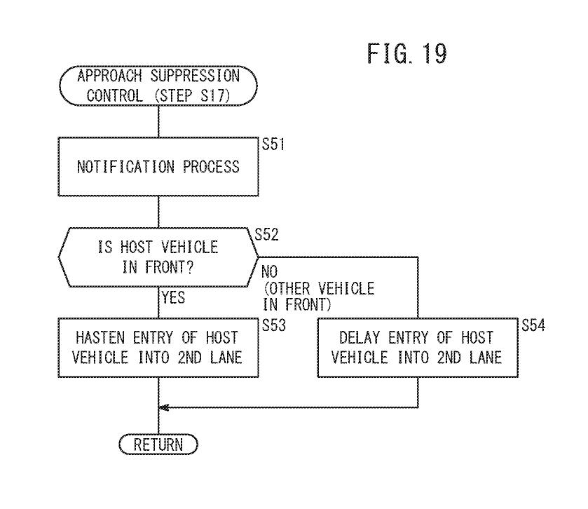

The notification control unit 220 controls a notification process for issuing a notification via the HMI 30. The steering assist control unit 222 controls a steering assist process through the EPS system 36. The acceleration/deceleration control unit 224 (acceleration/deceleration assist unit) controls an acceleration/deceleration process via the driving force control system 32 and the braking force control system 34. In the acceleration/deceleration process, the host vehicle 10 is automatically accelerated or decelerated by setting a target vehicle velocity. Alternatively, in the acceleration/deceleration process, the host vehicle 10 may be automatically accelerated or decelerated by setting a target vehicle acceleration or deceleration. The acceleration/deceleration control unit 224 is used in the modified examples of FIGS. 19 to 21B, to be described later.

### (A-1-11-4. Storage Unit 154)

The storage unit 154 stores programs and data used by the computation unit 152. The storage unit 154 includes, for example, a random access memory (hereinafter referred to as a “RAM”). As the RAM, a volatile memory such as a register or the like, and a nonvolatile memory such as a flash memory or the like can be used. Further, in addition to the RAM, the storage unit 154 may have a read only memory (hereinafter referred to as a “ROM”).

### <A-2. Lane Change Assist Control>

### [A-2-1. Outline of Lane Change Assist Control]

When the driver operates the steering wheel 94 or the like to make a lane change, the travel ECU 38 of the present embodiment executes a lane change assist control to provide assistance in making the lane change. The lane change assist control includes an adjacent lane target control (or a second lane target control), and a third lane target control.

The adjacent lane target control is a control to assist in making the lane change, which is performed in relation to the other vehicle 500 traveling in the adjacent lane LN2, when the host vehicle 10 makes a lane change from the travel lane LN1 (for example, the lane 302a of FIG. 2) into the adjacent lane LN2 (for example, the lane 302b of FIG. 2). The third lane target control is a control to assist in making the lane change, which is performed in relation to the other vehicle 500 traveling in the third lane LN3 (the lane LN on an opposite side from the travel lane LN1 with the adjacent lane LN2 interposed therebetween), when the host vehicle 10 makes a lane change from the travel lane LN1 into the adjacent lane LN2.

As the adjacent lane target control, for example, the control disclosed in JP 2009-262738 A can be used. The adjacent lane target control and the third lane target control can be carried out in parallel. The third lane target control will now be described below.

### [A-2-2. Outline of Third Lane Target Control]

FIG. 4 is a flowchart of the third lane target control in the present embodiment. In step S11, the travel ECU 38 determines whether or not the host vehicle 10 has started to make a lane change from the travel lane LN1 into the adjacent lane LN2. Details of such a determination will be described later. If the host vehicle 10 has started making a lane change (step S11: YES), the process proceeds to step S12. If the host vehicle 10 has not started making a lane change (step S11: NO), then the current third lane target control is terminated, and after the elapse of a predetermined time period, the process returns to step S11.

In step S12, the ECU 38 determines whether or not a third lane LN3, which is capable of being traveled in, exists alongside the adjacent lane LN2. As noted above, the third lane LN3 exists on an opposite side from the travel lane LN1 of the host vehicle 10 with the adjacent lane LN2 interposed therebetween, and is a lane LN having the same direction of travel as the travel lane LN1 and the adjacent lane LN2. If such a third lane LN3 exists (step S12: YES), the process proceeds to step S13. If such a third lane LN3 does not exist (step S12: NO), then the current third lane target control is terminated, and after the elapse of a predetermined time period, the process returns to step S11.

In step S13, the ECU 38 determines whether or not another vehicle 500 (see FIG. 5, etc.) is present in the third lane LN3. If another vehicle 500 is present in the third lane LN3 (step S13: YES), the process proceeds to step S14. If another vehicle 500 is not present in the third lane LN3 (step S13: NO), then the current third lane target control is terminated, and after the elapse of a predetermined time period, the process returns to step S11.

In step S14, the ECU 38 determines whether or not the other vehicle 500 has started to make a lane change from the third lane LN3 into the second lane LN2. If the other vehicle 500 has started making a lane change into the second lane LN2 (step S14: YES), the process proceeds to step S15. If the other vehicle 500 has not started to make a lane change into the second lane LN2 (step S14: NO), for example, if the other vehicle 500 remains in the third lane LN3, then the current third lane target control is terminated, and after the elapse of a predetermined time period, the process returns to step S11.

In step S15, the ECU 38 determines the possibility of contact Pc between the host vehicle 10 and the other vehicle 500. If the possibility of contact Pc is high (step S16: YES), then in step S17, the ECU 38 executes the approach suppression control in order to prevent the host vehicle 10 and the other vehicle 500 from approaching each other. After step S17 or in the case that the possibility of contact Pc is not high (step S16: NO), the process proceeds to step S18.

In step S18, the ECU 38 determines whether or not the lane change made by the host vehicle 10 has ended or has been canceled. If the lane change made by the host vehicle 10 has ended or has been canceled (step S18: YES), then the current third lane target control is terminated, and after the elapse of a predetermined time period, the process returns to step S11. If the lane change made by the host vehicle 10 has not ended and has not been canceled (step S18: NO), the process proceeds to step S19.

In step S19, the ECU 38 determines whether or not the lane change into the second lane LN2 made by the other vehicle 500 has ended or has been canceled. If the lane change into the second lane LN2 made by the other vehicle 500 has ended or has been canceled (step S19: YES), then the current third lane target control is terminated, and after the elapse of a predetermined time period, the process returns to step S11. If the lane change made by the other vehicle 500 has not ended and has not been canceled (step S19: NO), the process returns to step S15.

[A-2-3. Determination of Start of Lane Change by Host Vehicle 10 (step S11 of FIG. 4)]

According to the present embodiment, for example, in the case that the blinker switch 88 is switched on (condition 1), the ECU 38 determines that the host vehicle 10 has started to make a lane change. Alternatively, the ECU 38 may determine that the host vehicle 10 has started to make a lane change, in the case that the host vehicle 10 has straddled the lane marking LM (hereinafter referred to as a “near side lane marking LM2near”) on the near side of the second lane LN (lane division line) (condition 2). Alternatively, the ECU 38 can determine that the host vehicle 10 has started to make a lane change, in the case that both condition 1 and condition 2 have been satisfied (condition 3). Alternatively, the ECU 38 may determine that the host vehicle 10 has started to make a lane change, in the case that condition 3 has been satisfied and the ECU 38 has detected the adjacent lane LN2 (condition 4).

[A-2-4. Determination of Presence or Absence of Third Lane (step S12 of FIG. 4)]

FIG. 5 is an explanatory diagram for describing a method of detecting the respective lanes LN in the present embodiment. In the same manner as in FIG. 2, in FIG. 5, the lane 302a is the travel lane LN1 (first lane) for the host vehicle 10, and the lane 302b is the adjacent lane LN2 (second lane) adjacent to the travel lane 302a. Further, the lane 302c is a third lane LN3 positioned on the opposite side of the travel lane LN1 with the adjacent lane 302b interposed therebetween. The lane 302a is defined by the lane markings 304a and 304b, the lane 302b is defined by the lane markings 304b and 304c, and the lane 302c is defined by the lane markings 304c and 304d.

In FIG. 5, a case is shown in which the leftmost lane 302a in the direction of travel is the travel lane LN1 of the host vehicle 10, whereas the lane 302b (the second lane LN2) and the lane 302c (the third lane LN3) exist on the right side thereof. However, the present invention is not limited to this feature. For example, in the case that the host vehicle 10 is traveling in the lane 302c in FIG. 5, the lane 302c is regarded as the travel lane LN1 of the host vehicle 10, the lane 302b is regarded as the adjacent lane LN2, and the lane 302a is regarded as the third lane LN3.

The ECU 38 determines the presence or absence of the third lane LN3 on the basis of the image information Iimage acquired by the vehicle exterior cameras 50. More specifically, the ECU 38 extracts the respective lane markings LM (the lane markings 304a, 304b, 304c, 304d of FIG. 5) from the image information Iimage, and calculates each of the lanes LN (lanes 302a, 302b, 302c of FIG. 5). Next, from among the calculated lanes LN, the ECU 38 specifies the travel lane LN1 of the host vehicle 10.

For example, when the host vehicle 10 is traveling straight ahead, cases may occur in which it is difficult to recognize the third lane LN3 within the image information Iimage, due to the relationship of the angle of view of the camera 50, the resolution of the lens, and the like. Thus, according to the present embodiment, the ECU 38 recognizes that the lane is the third lane LN3, in the case that the distance Dlm between the adjacent lane markings LM (in other words, the width of the third lane LN, see FIG. 2) is greater than or equal to a distance threshold value THdlm. The second lane LN2 can be recognized in the same manner.

In addition to or instead of the image information Iimage, the presence or absence of the third lane LN3 may be determined on the basis of the current position Pgps of the host vehicle 10 and the map information Imap. More specifically, based on the current position Pgps and the map information Imap, the ECU 38 determines whether or not there are a plurality of lanes LN on the road 300 on which the host vehicle 10 is traveling. Next, based on the current position Pgps and the map information Imap, the ECU 38 determines which lane LN the host vehicle 10 is traveling in. Next, with reference to the travel lane LN1 of the host vehicle 10, it is determined whether or not there is another lane LN (the third lane LN3 or the like) in which vehicles are capable of traveling, and located more on the far side than the adjacent lane LN2 (target lane) that is regarded as the lane change target.

As noted above, according to the present embodiment, the imaging range Rcamera of the vehicle exterior cameras 50 is not directed toward the lateral sides of the host vehicle 10. Thus, in the case it is determined that the third lane LN3 exists on the basis of the image information Iimage (forward image), the ECU 38 extends the lane marking LM, which was extracted from the image information Iimage (hereinafter also referred to as a “far side lane marking LM2far”) and is shared by the second lane LN2 and the third lane LN3, to the lateral side and rearwardly of the host vehicle 10, and specifies the position Plm2far of the far side lane marking LM2far or the position Pln2 of the adjacent lane LN2. In the case of FIG. 5, the lane marking 304c is the far side lane marking LM2far of the second lane LN2.

In FIG. 5, a portion 310 of the lane marking 304c making up the far side lane marking LM2far is a portion recognized from the image information Iimage, whereas a portion 312 thereof is a portion of the lane marking 304c that is estimated by the ECU 38 on the basis of the portion 310. Further, in FIG. 5, a portion 314 of the lane marking 304b making up the near side lane marking LM2near is a portion recognized from the image information Iimage.

Alternatively, in the case that the width Wln2 of the second lane LN2 is included in the map information Imap, the ECU 38 may calculate the position of the far side lane marking LM2far on the basis of the position Plm2near of the near side lane marking LM2near, and the width Wln2 of the second lane LN2.

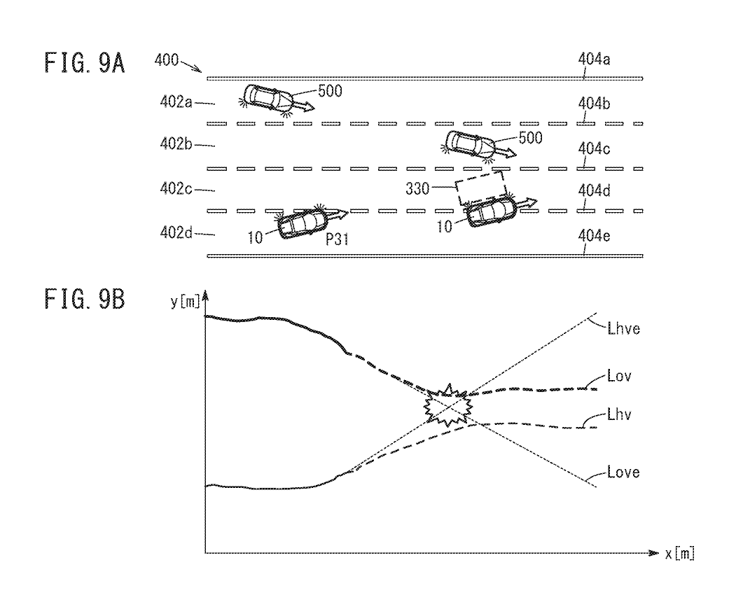

Further, a case may also be assumed in which the number of lanes on one side of the road 300 is four or more. In such a case, the ECU 38 may simply determine in step S12 whether or not there is at least one lane in which traveling is possible, on an opposite side from the travel lane LN1 of the host vehicle 10 with the adjacent lane LN2 interposed therebetween. In this case, as will be discussed later with reference to FIG. 9A, a determination may be made as to which lane LN the other vehicle 500 is traveling in.

[A-2-5. Determination of Presence or Absence of Other Vehicle 500 in Third Lane LN3 (step S13 of FIG. 4)]

The ECU 38 determines whether or not another vehicle 500 is present in the third lane LN3, which was specified as described above, based on the radar information Iradar from the radar devices 52 and the image information Iimage from the cameras 50. For example, the ECU 38 calculates the size and movement velocity of external obstacles based on the radar information Iradar (reflected waves), and determines the presence or absence of the other vehicle 500. Further, the ECU 38 performs pattern matching on the image information Image in order to determine the presence or absence of the other vehicle 500. Moreover, concerning a range in which the imaging range Rcamera of the cameras 50 and the detection range Rradar of the radar devices 52 overlap, the other vehicle 500 may be detected by combining the image information Iimage and the radar information Iradar.

### [A-2-6. Determination of Start of Lane Change by the Other Vehicle 500 (Step S14 of FIG. 4)]

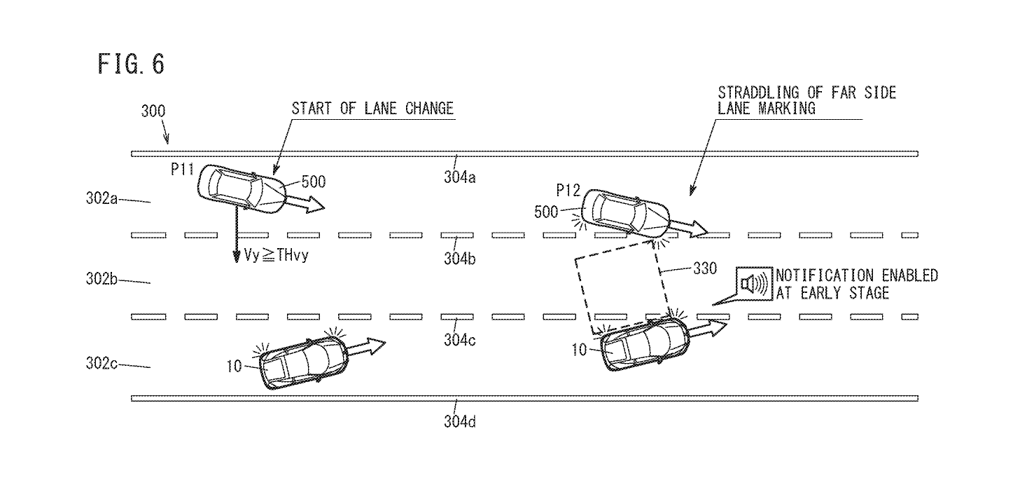

FIG. 6 is an explanatory diagram for describing a state, according to the present embodiment, in which the travel ECU 38 of the host vehicle 10 recognizes a lane change made by the other vehicle 500. In comparison with FIG. 2 and FIG. 5, in FIG. 6, the positional relationship between the host vehicle 10 and the other vehicle 500 is reversed. More specifically, in FIG. 6, the lane 302c is the travel lane LN1 (first lane) of the host vehicle 10, and the lane 302a is the third lane LN3.

On the basis of the image information Iimage from the cameras 50 and the radar information Iradar of the radar devices 52, the ECU 38 determines the start of a lane change made by the other vehicle 500 with respect to the second lane LN2 (lane 302b). More specifically, in the case that the velocity Vy of the other vehicle 500 with respect to a direction perpendicular to the direction of travel of the road 300 (in other words, the width direction of the respective lanes LN) is greater than or equal to a velocity threshold value THvy, the ECU 38 determines that the other vehicle 500 has started to make a lane change (refer to point P11 in FIG. 6). Consequently, even before a state in which the other vehicle 500 straddles over the lane marking LM shared by the second lane LN2 and the third lane LN3 (the far side lane marking LM2far, i.e., the lane marking 304b), it is easy to detect the start of the lane change by the other vehicle 500. In accordance therewith, it is possible for a notification to be issued at an early stage (at the point P12 in FIG. 6).

The velocity Vy of the other vehicle 500 in the width direction of the respective lanes LN can also be calculated using the radar information Iradar (or the image information Iimage). At this time, the ECU 38 may manage the far side lane marking LM2far of the second lane LN2 as well as the other vehicle 500 on a two-dimensional plane as viewed in plan.

Moreover, the ECU 38 is also capable of determining that the other vehicle 500 has started to make a lane change with respect to the second lane LN2 when the distance Dlmov between the far side lane marking LM2far of the second lane LN2 (for example, the lane marking 304c shown in FIG. 5) and the other vehicle 500 becomes less than or equal to a distance threshold value THdlmov. The distance threshold value THdlmov, for example, can be set to a value by which it is determined that the other vehicle 500 has straddled over the far side lane marking LM2far. Alternatively, in the case that the other vehicle 500 is included within the image information Iimage, the start of the lane change by the other vehicle 500 may be determined by detecting that the far side lane marking LM2far and the other vehicle 500 have come into contact.

It is also possible to combine the processes of steps S12 and S13. For example, the ECU 38 can determine whether or not another vehicle 500 is present, which is traveling in the same direction as the host vehicle 10 at a vehicle velocity V higher than a vehicle velocity threshold value THv, at a position more distanced from the travel lane LN1 of the host vehicle 10 than the adjacent lane LN2, which is regarded as a target lane for the lane change.

[A-2-7. Determination of Possibility of Contact Pc Between Host Vehicle 10 and Other Vehicle 500 (step S15 of FIG. 4)]

### (A-2-7-1. Overall Flow)

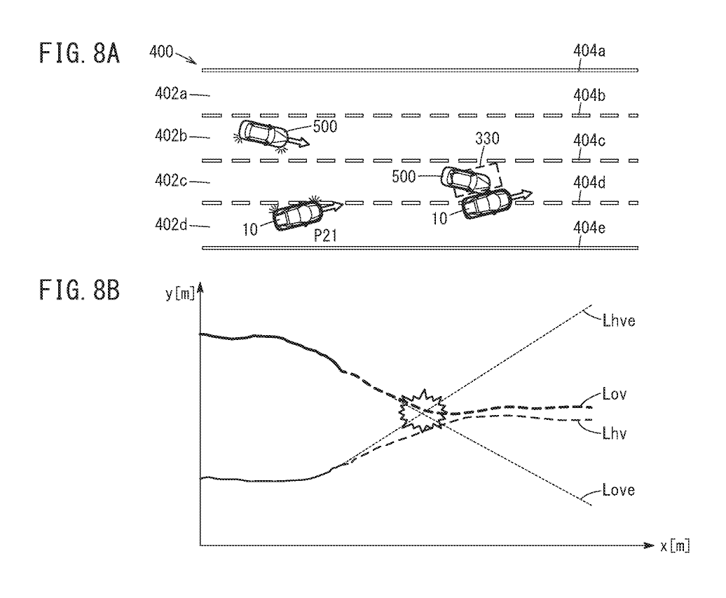

FIG. 7 is a flowchart (details of step S15 of FIG. 4) for determining a possibility of contact Pc between the host vehicle 10 and the other vehicle 500 in the present embodiment. FIGS. 8A and 9A are diagrams showing first and second examples of a positional relationship between the host vehicle 10 and the other vehicle 500, for the purpose of determining the possibility of contact Pc in the present embodiment.

FIG. 8B is a view showing actual travel trajectories Lhv, Lov of the host vehicle 10 and the other vehicle 500, and predicted trajectories Lhve, Love of the host vehicle 10 and the other vehicle 500 when the host vehicle 10 is at the point P21. The travel trajectories Lhv, Lov until the host vehicle 10 reaches the point P21 in FIG. 8A are indicated by solid lines. The travel trajectories Lhv, Lov after the host vehicle 10 has reached the point P21 in FIG. 8A are indicated by dashed lines.

FIG. 9B is a view showing actual travel trajectories Lhv, Lov of the host vehicle 10 and the other vehicle 500, and predicted trajectories Lhve, Love of the host vehicle 10 and the other vehicle 500 when the host vehicle 10 is at the point P31. The travel trajectories Lhv, Lov until the host vehicle 10 reaches the point P31 in FIG. 9A are indicated by solid lines. The travel trajectories Lhv, Lov after the host vehicle 10 has reached the point P31 in FIG. 9A are indicated by dashed lines.

The road 400 in FIGS. 8A and 9A includes four lanes 402a, 402b, 402c, 402d on one side (lanes also exist on an opposite side not shown in FIG. 9A). The lane 402a is defined by the lane markings 404a and 404b. The lane 402b is defined by the lane markings 404b and 404c. The lane 402c is defined by the lane markings 404c and 404d. The lane 402d is defined by the lane markings 404d and 404e.

In FIG. 8A, the lane 402d is a travel lane LN1 (first lane) in which the host vehicle 10 travels, the lane 402c is an adjacent lane LN2 (second lane), and the lane 402b is a third lane LN3. The lane 402a is not used in the third lane target control (FIG. 4).

In FIG. 9A, the lane 402d is a travel lane LN1 (first lane) in which the host vehicle 10 travels, the lane 402c is an adjacent lane LN2 (second lane), and the lane 402a is a third lane LN3 in which the other vehicle 500 travels. The lane 402b is a fourth lane LN4 existing between the second lane LN2 and the third lane LN3. The lanes 402a and 402b are lanes that exist on an opposite side from the lane 402d with the lane 402c interposed therebetween.

In step S21 of FIG. 7, the ECU 38 calculates the predicted trajectory Lhve (see FIGS. 8B and 9B) of the host vehicle 10. In step S22, the ECU 38 calculates the predicted trajectory Love (see FIGS. 8B and 9B) of the other vehicle 500.

In step S23, the ECU 38 determines whether or not the adjacent lane LN2 (second lane) and the travel lane LN3 (third lane) of the other vehicle 500 are adjacent to each other. Stated otherwise, the ECU 38 confirms that a fourth lane LN4 (for example, the lane 402b in FIG. 9A) does not exist between the second lane LN2 and the third lane LN3. In the case that the second lane LN2 and the third lane LN3 are adjacent to each other (step S23: YES), the process proceeds to step S24. If the second lane LN2 and the third lane LN3 are not adjacent to each other (step S23: NO), or in other words, if a fourth lane LN4 exists between the second lane LN2 and the third lane LN3, the process proceeds to step S27.

In step S24, the ECU 38 calculates the operation target range 330 at respective future points in time. The operation target range 330 is a region within which the ECU 38 executes the approach suppression control (details of which will be described later with reference to FIG. 10, etc.).

In step S25, the ECU 38 determines whether or not the predicted trajectory Love of the other vehicle 500 is included within the operation target range 330 at any future point in time. In the case that the predicted trajectory Love of the other vehicle 500 is included within the operation target range 330 (step S25: YES), then in step S26, the ECU 38 determines that the possibility of contact Pc between the host vehicle 10 and the other vehicle 500 is high. If the answer in step S23 is NO, or in the case that the predicted trajectory Love of the other vehicle 500 is not included within the operation target range 330 (step S25: NO), then in step S27, the ECU 38 determines that the possibility of contact Pc between the host vehicle 10 and the other vehicle 500 is low.

(A-2-7-2. Calculation of Predicted Trajectories Lhve, Love of the Host Vehicle 10 and the Other Vehicle 500 (steps S21, S22 of FIG. 7))

The ECU 38 calculates the predicted trajectory Lhve of the host vehicle 10 on the basis of the current position Pgps, the vehicle velocity V, and the lateral acceleration Glat of the host vehicle 10. Further, the ECU 38 calculates the predicted trajectory Love of the other vehicle 500 on the basis of at least one of the image information Iimage and the radar information Iradar.

(A-2-7-3. Determination of Whether Second Lane LN2 and Third Lane LN3 are Adjacent (step S23 of FIG. 7))

As described above, in step S23 of FIG. 7, a determination is made as to whether the second lane LN2, which lies adjacent to the first lane LN1 as the travel lane of the host vehicle 10, is also adjacent to the third lane LN3 as the travel lane of the other vehicle 500. Such a determination can be regarded as a determination as to whether or not another fourth lane LN4 (such as the lane 402b in FIG. 9A) exists between the second lane LN2 and the third lane LN3.

The presence or absence of a fourth lane LN4 between the second lane LN2 and the third lane LN3 can be determined on the basis of, for example, a distance Dpho between the host vehicle 10 and the other vehicle 500 at that current point in time. For example, the ECU 38 is capable of determining that a fourth lane LN4 exists if the distance Dpho between the host vehicle 10 and the other vehicle 500 corresponds to a width of two lanes or more.

Alternatively, it also is possible to perform the determination in step S23 on the basis of the predicted trajectories Lhve, Love of the host vehicle 10 and the other vehicle 500. For example, it can be determined that a fourth lane LN4 exists between the second lane LN2 and the third lane LN3 in the event that the predicted trajectories Lhve, Love do not intersect within a predetermined time period from the current point in time. Alternatively, it can be determined that a fourth lane LN4 exists between the second lane LN2 and the third lane LN3 in the event that a distance Dlho between points on the predicted trajectories Lhve, Love at an arbitrary point in time within a predetermined time period from the current point in time is greater than or equal to a predetermined distance threshold value THdlho.

### (A-2-7-4. Calculation of Operation Target Range 330 (Step S24 of FIG. 7)

### (A-2-7-4-1. Outline)

FIGS. 10 to 14 are explanatory diagrams showing first to fifth patterns in relation to a method of calculating an operation target range 330, which are capable of being used in the present embodiment. The travel ECU 38 calculates the operation target range 330 using one of the first to fifth patterns. Alternatively, the ECU 38 calculates the operation target range 330 using a combination of a plurality of the first to fifth patterns. For example, combinations of the first to fifth patterns can simply be a superimposition of the operation target ranges 330 calculated using the respective patterns.

As will be described below, the current position Pgps of the host vehicle 10 and the position Plm2far of the far side lane marking LM2far of the second lane LN2 are used in any of the first to fifth patterns. As noted above, in the position Plm2far of the far side lane marking LM2far, a portion of the far side lane marking LM2far (portion 310 in FIG. 5) included within the image information Iimage can be calculated on the basis of image information Iimage. Further, a portion (for example, the portion 312 shown in FIG. 5) of the far side lane marking LM2far which is not included within the image information Iimage, is calculated by extending the portion included within the image information Iimage. Alternatively, in the case that the width Wln2 of the second lane LN2 is included within the map information Imap, the position of the far side lane marking can be calculated on the basis of the position Plm2near of the near side lane marking LM2near included within the image information Iimage.

The operation target range 330 of the present embodiment is set so as not to enter into the third lane LN3. Owing thereto, it is possible to prevent the predicted trajectory Love of the other vehicle 500 (or the other vehicle 500 itself) that is traveling in the third lane LN3 without making a lane change from entering into the operation target range 330. However, as long as the operation target range 330 enters only slightly into the third lane LN3 from the far side lane marking LM2far, substantially the same effects as described above can be achieved.

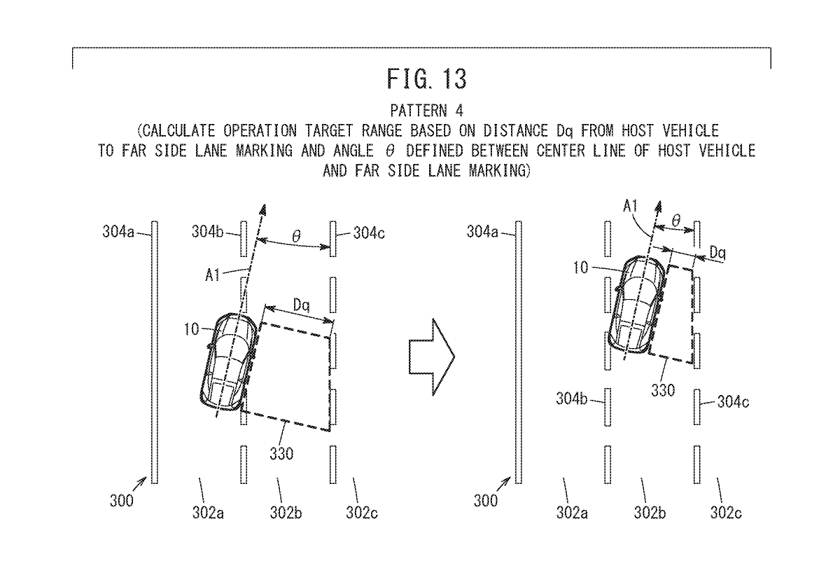

Further, according to the present embodiment, among the sides of the host vehicle 10 (vehicle body), the operation target range 330 is set on a lateral side on the side of the second lane LN2. The operation target range 330 may be set not only on a lateral side of the host vehicle 10, but also diagonally forward and/or diagonally rearward of the host vehicle 10. Moreover, with the first to third patterns and the fifth pattern (see FIGS. 10 to 12 and 14), the operation target range 330 is formed in a rectangular shape, and the fourth pattern (see FIG. 13) is formed in a trapezoidal shape. However, the shapes of the operation target range 330 are not limited to these features.

### (A-2-7-4-2. First Pattern)

With the first pattern shown in FIG. 10, the ECU 38 calculates the operation target range 330, on the basis of the current position Pgps of the host vehicle 10, the position Plm2far of the far side lane marking LM2far, and the lateral acceleration Glat of the host vehicle 10. More specifically, the ECU 38 sets a predetermined operation target range 330 at the point in time that the lane change is started. In addition, the ECU 38 estimates a distance Dq to the far side lane marking LM2far responsive to the lateral acceleration Glat, and thereby sets the size of the operation target range 330. The distance Dq is a length, in the vehicle widthwise direction of the host vehicle 10, from the host vehicle 10 to the far side lane marking LM2far. As shown in FIG. 10, the operation target range 330 becomes smaller responsive to the lateral acceleration Glat, when the host vehicle 10 moves toward the adjacent lane LN2.

### (A-2-7-4-3. Second Pattern)

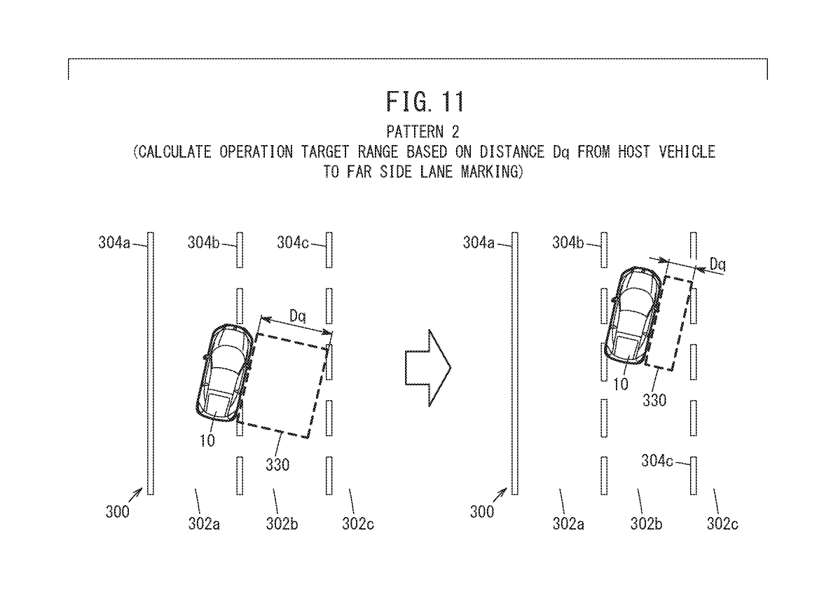

With the second pattern shown in FIG. 11, the ECU 38 calculates the operation target range 330, on the basis of the distance Dq between the host vehicle 10 and the far side lane marking LM2far. The distance Dq, in the same manner as the first pattern, is defined by a length in the vehicle widthwise direction from the host vehicle 10 to the far side lane marking LM2far. With the first pattern, although the distance Dq was defined using the lateral acceleration Glat, etc., with the second pattern, the distance Dq continues to be calculated while updating the current position Pgps of the host vehicle 10 and the far side lane marking LM2far. As shown in FIG. 11, the operation target range 330 becomes smaller as the host vehicle 10 moves toward the adjacent lane LN2 and the distance Dq becomes shorter.

### (A-2-7-4-4. Third Pattern)

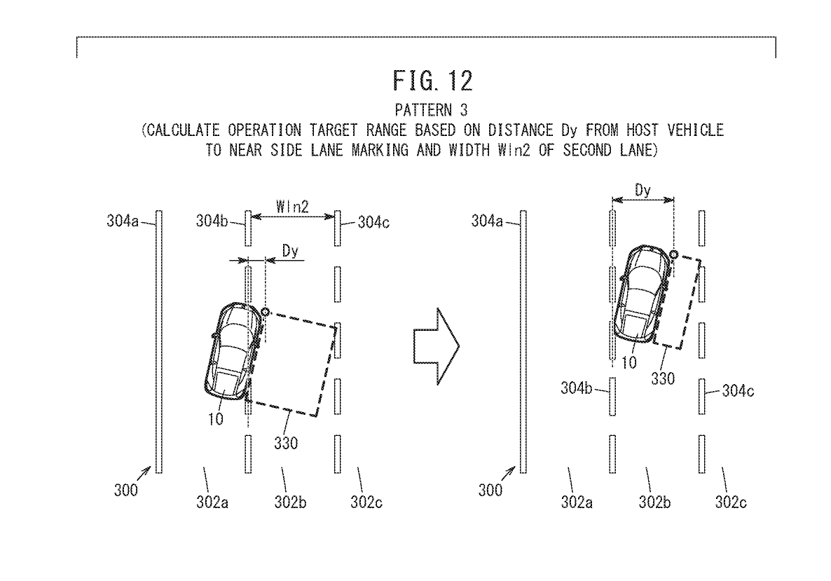

With the third pattern shown in FIG. 12, the operation target range 330 is calculated on the basis of a distance Dy between the host vehicle 10 and the near side lane marking LM2near in a direction perpendicular to the near side lane marking LM2near, and the width Wln2 of the second lane LN2. The distance Dy is calculated based on the current position Pgps of the host vehicle 10 and the near side lane marking LM2near. Further, the width Wln2 of the second lane marking LN2 is calculated, for example, based on the image information Iimage. Alternatively, the width Wln2 can be acquired on the basis of the map information Imap. As shown in FIG. 12, the operation target range 330 becomes smaller as the host vehicle 10 moves toward the adjacent lane LN2 and the distance Dy becomes longer.

### (A-2-7-4-5. Fourth Pattern)

With the fourth pattern shown in FIG. 13, the operation target range 330 is calculated, on the basis of the distance Dq between the host vehicle 10 and the far side lane marking LM2far, and an angle θ defined by the center line A1 of the host vehicle 10 (an imaginary line along the frontal direction of the host vehicle 10) and the far side lane marking LM2far. By adding the angle θ to the information used by the second pattern, the operation target range 330 is set to a trapezoidal shape.

### (A-2-7-4-6. Fifth Pattern)

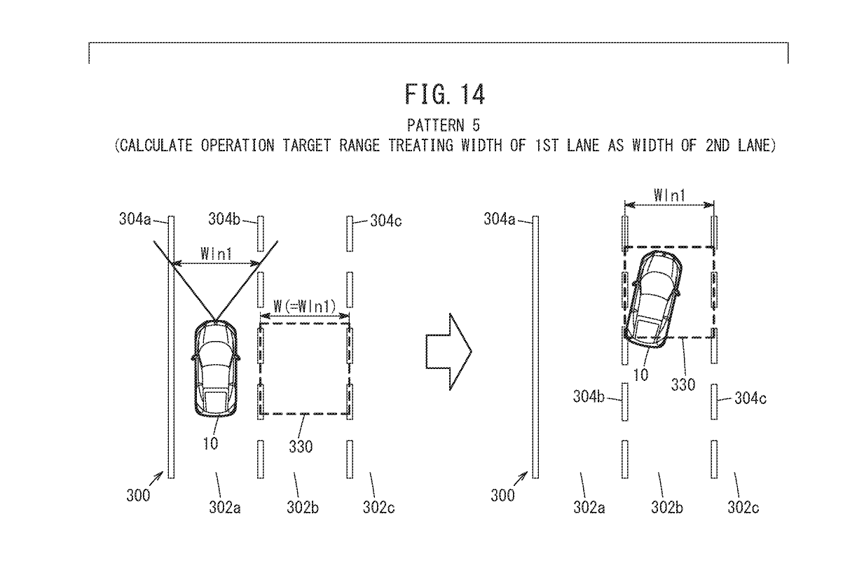

With the fifth pattern shown in FIG. 14, the operation target range 330 is calculated on the basis of the current position Pgps of the host vehicle 10, the position Plm2near of the near side lane marking LM2near, and the width Wln1 of the travel lane LN1 (for example, the lane 302a shown in FIG. 14). More specifically, as shown in FIG. 14, the width W of the operation target range 330 is always set to be equivalent to the width Wln1. In addition, the ECU 38 sets the operation target range 330 by taking the position Plm2near of the near side lane marking LM2near as a reference position in a direction perpendicular to the second lane LN2, and taking the current position Pgps of the host vehicle 10 as a reference position in a direction along the second lane LN2.

(A-2-7-5. Calculation of Positional Relationship Between the Operation Target Range 330 and the Predicted Trajectory Love of the Other Vehicle 500 (step S25 of FIG. 7))

As noted above, the operation target range 330 is calculated with reference to the current position Pgps of the host vehicle 10 (see FIGS. 10 to 14). Stated otherwise, the operation target range 330 moves while undergoing modification along the predicted trajectory Lhve of the host vehicle 10 (or in other words, with the passage of time).

The ECU 38 calculates a positional relationship between the operation target range 330 and a point on the predicted trajectory Love of the other vehicle 500, in a predetermined time period (for example, any time period from 1 to 10 seconds) from the current time. In addition, at any point in time within the predetermined time period, it is calculated whether or not the point on the predicted trajectory Love of the other vehicle 500 enters inside of the operation target range 330.

[A-2-8. Approach Suppression Control (step S17 of FIG. 4)]

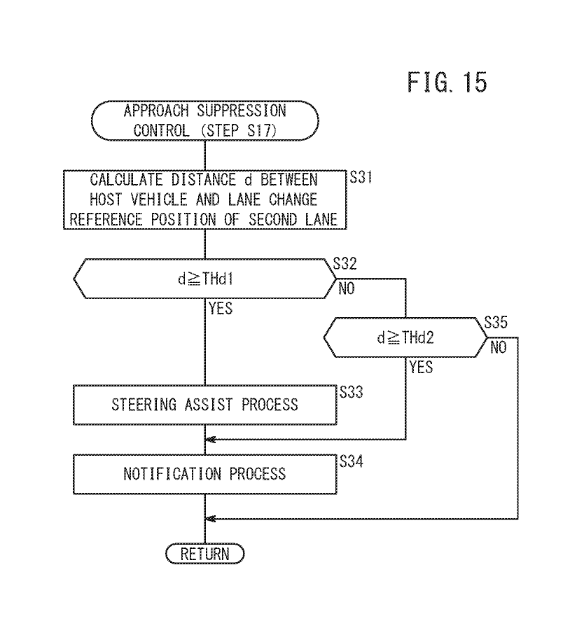

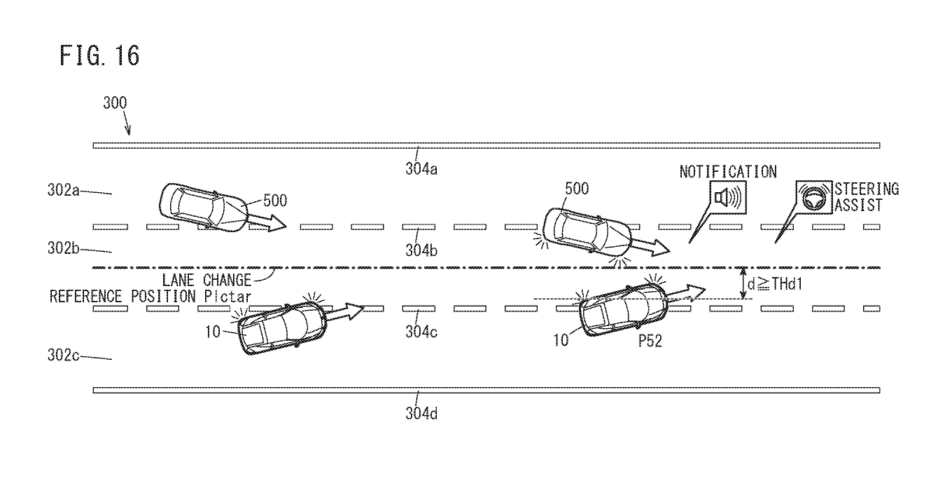

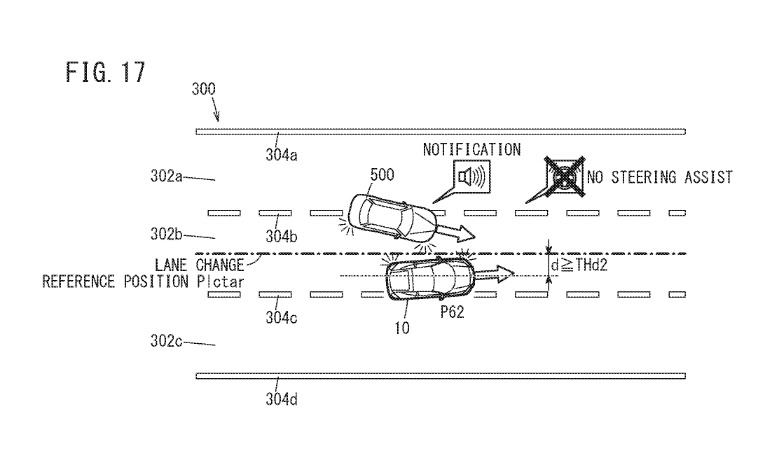

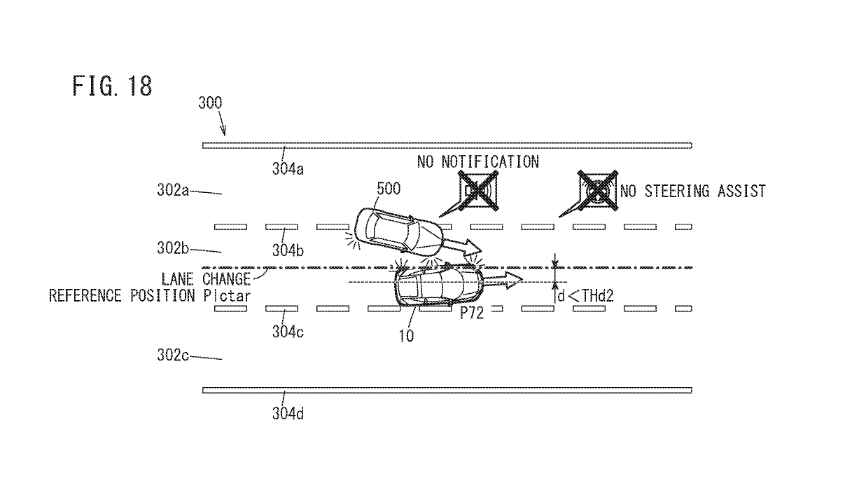

FIG. 15 is a flowchart of the approach suppression control according to the present embodiment. FIGS. 16 to 18 are first through third explanatory diagrams for describing the approach suppression control of the present embodiment. More specifically, FIG. 16 is a diagram showing a position P52 of the host vehicle 10 and a control associated therewith, in the case that the answer to step S32 of FIG. 15 is YES. FIG. 17 is a diagram showing a position P62 of the host vehicle 10 and a control associated therewith, in the case that the answer to step S35 of FIG. 15 is YES. FIG. 18 is a diagram showing a position P72 of the host vehicle 10 and a control associated therewith, in the case that the answer to step S35 of FIG. 15 is NO.

In step S31 of FIG. 15, the ECU 38 calculates the distance d between the host vehicle 10 and a lane change reference position Plctar of the second lane LN2. The lane change reference position Plctar is a target position of the second lane LN2 at a time that a lane change is made by the host vehicle 10 from the first lane LN1 (for example, lane 302c in FIG. 16) into the second lane LN2 (for example, lane 302b in FIG. 16). The lane change reference position Plctar can be set, for example, to the center in a widthwise direction of the second lane LN2.

In step S32, the ECU 38 determines whether or not the distance d is greater than or equal to a first distance threshold value THd1. The first distance threshold value THd1 is a threshold value used for determining whether or not the distance d is comparatively large. If the distance d is greater than or equal to the first distance threshold value THd1 (step S32 of FIG. 16: YES), the process proceeds to step S33.

In step S33, the ECU 38 executes the steering assist process. The steering assist process is a process for assisting steering in such a manner that the host vehicle 10 separates away from the other vehicle 500. When the steering assist process is preformed, the travel ECU 38 issues a command with respect to the EPS ECU 142 in order to operate the EPS motor 140. Moreover, concerning steering (or turning) of the vehicle 10, in addition to or instead of using the EPS motor 140, it also is possible to utilize a torque difference (so-called torque vectoring) between the left and right wheels.

In the following step S34, the ECU 38 carries out a notification process. The notification process is a process to notify the driver of the existence of another vehicle 500 via the HMI 30. More specifically, the ECU 38 issues a notification concerning the existence of another vehicle 500, using a warning display on the meter display 110 (see FIG. 1), output of a warning sound from the speaker 112, generation of vibrations by the vibration imparting device 114 provided in the lumbar support, and emission of light emitted by the door mirror indicator 116. Accordingly, in the case that the distance d becomes greater than or equal to the first distance threshold value THd1, the ECU 38 performs both the steering assist process (step S33) and the notification process (step S34) (see FIG. 16).

Returning to step S32, in the case that the distance d is not greater than or equal to the first distance threshold value THd1 (step S32: NO), then in step S35, the ECU 38 determines whether or not the distance d is greater than or equal to a second distance threshold value THd2. The second distance threshold value THd2 is a threshold value used for determining whether or not the distance d is comparatively small. If the distance d is greater than or equal to the second distance threshold value THd2 (step S35: YES, FIG. 17), then in step S35, the ECU 38 executes the notification process. Accordingly, in the case that the distance d becomes greater than or equal to the second distance threshold value THd2 and is less than the first distance threshold value THd1, the ECU 38 executes the notification process (step S34), but does not carry out the steering assist process (step S33) (see FIG. 17).

In the case that the distance d is not greater than or equal to the second distance threshold value THd2 (step S35: NO), the ECU 38 terminates the current approach suppression control (see FIG. 15). Accordingly, in the case that the distance d is less than the second distance threshold value THd2, the ECU 38 does not perform either one of the steering assist process (step S33) or the notification process (step S34) (see FIG. 18).

### [A-2-9. Determination of End or Cancellation of Lane Change by Host Vehicle 10 (Step S18 of FIG. 4)]

When the current position Pgps of the host vehicle 10 reaches the lane change reference position Plctar (see FIG. 16, etc.), the ECU 38 determines that the lane change by the host vehicle 10 has ended (step S18 of FIG. 4: YES). Further, after having determined that the host vehicle 10 has started making a lane change (step S11 of FIG. 4: YES), if the host vehicle 10 straddles over the lane marking LM while moving toward the first lane LN1 (i.e., the host vehicle 10 returns to the side of the first lane LN1), the ECU 38 determines that the host vehicle 10 has canceled the lane change (step S18 of FIG. 4: YES).

### [A-2-10. Determination of End or Cancellation of Lane Change by Other Vehicle 500 (Step S19 of FIG. 4)]

When the current position Pgps of the other vehicle 500 reaches the lane change reference position Plctar, the ECU 38 determines that the lane change by the other vehicle 500 has ended (step S19 of FIG. 4: YES). In this case, since the host vehicle 10 has not yet completed making the lane change, the ECU 38 switches the control with respect to the other vehicle 500 from the third lane target control to the adjacent lane target control, and continues with the lane change.

Further, in the case that the other vehicle 500 does not straddle over the far side lane marking LM2far even after a predetermined time period has elapsed since the determination that the other vehicle 500 has started making the lane change (step S14 of FIG. 4: YES), the ECU 38 determines that the other vehicle 500 has canceled the lane change (step S19 of FIG. 4: YES). Alternatively, after having determined that the other vehicle 500 has started making a lane change (step S14 of FIG. 4: YES), if the other vehicle 500 returns to the side of the third lane LN3, the ECU 38 determines that the other vehicle 500 has canceled the lane change (step S19 of FIG. 4: YES).

### <A-3. Advantages and Effects of the Present Embodiment>

According to the present embodiment, when the host vehicle 10 makes a lane change from the travel lane LN1 (first lane) of the host vehicle 10 into the adjacent lane LN2 (second lane, target lane) (step S11 of FIG. 4: YES), approaching between the host vehicle 10 and the other vehicle 500 is suppressed (step S17), in the case that the other vehicle 500 is making a lane change from the third lane LN3 (a lane LN existing on an opposite side from the travel lane LN1 with the adjacent lane LN2 interposed therebetween) into the adjacent lane LN2 (step S14: YES). In accordance with this feature, it is possible to enhance the merchantability of the host vehicle 10.

In the present embodiment, the travel assist device 12 comprises the lane information computation unit 200 (lane information acquisition unit) that acquires position information Ipln2 of the adjacent lane LN2 (second lane), the other vehicle predicted trajectory computation unit 210 (other vehicle information acquisition unit) that acquires position information Ipov of the other vehicle 500, and the approach suppression operation unit 14 that performs the approach suppression operation to prevent the host vehicle 10 and the other vehicle 500 from approaching each other, on the basis of a command from the travel ECU 38 (approach suppression control unit) (see FIGS. 1 and 3).

Further, the approach suppression operation unit 14 is equipped with the HMI 30 (notifying unit) that notifies a vehicle occupant of the presence of the other vehicle 500, and the EPS system 36 (behavior control unit) that controls the behavior of the host vehicle 10 to thereby prevent the host vehicle 10 from approaching with respect to the other vehicle 500 (see FIG. 1).

The travel ECU 38 (approach suppression control unit) sets the operation target range 330, by which the approach suppression operation unit 14 is made to carry out the approach suppression operation, on the basis of the current position Pgps (position information Iphv) of the host vehicle 10, and the position Pln2 (position information Ipln2) of the adjacent lane LN2 (second lane) (step S24 of FIG. 7, FIGS. 10 to 14). In the case it is determined that the other vehicle 500 has entered into the operation target range 330, or in the event it is estimated that the other vehicle 500 will enter into the operation target range 330 (step S25 of FIG. 7: YES), the ECU 38 causes the approach suppression operation unit 14 to carry out the approach suppression operation (steps S33, S34 of FIG. 15).

According to the above description, the approach suppression control is carried out in the case it is determined that the other vehicle 500 has entered into the operation target range 330, or in the case it is estimated that the other vehicle 500 will enter into the operation target range 330. Stated otherwise, the approach suppression control is not carried out in the case that the other vehicle 500, while traveling in the third lane LN3, has not entered into the operation target range 330, or in the case it is not estimated that the other vehicle 500 will enter into the operation target range 330. In accordance with this feature, it is possible to enhance the merchantability of the host vehicle 10, by selecting the other vehicle 500 that has influence on a lane change of the host vehicle 10, and performing the approach suppression operation.

In the present embodiment, the lane information computation unit 200 (lane information acquisition unit) acquires the width information of the adjacent lane LN2, which is indicative of the distance between the near side lane marking LM2near and the far side lane marking LM2far of the adjacent lane LN2, or the position information Iplm2far of the far side lane marking LM2far (refer to FIGS. 10 to 14). The travel ECU 38 (approach suppression control unit) sets the operation target range 330 on the basis of the width information of the adjacent lane LN2 or the position information Iplm2far of the far side lane marking LM2far (see FIGS. 10 to 14). Consequently, by setting the operation target range 330 on the basis of the width information of the adjacent lane LN2 or the position information Iplm2far of the far side lane marking LM2far, it is possible to appropriately grasp the positional relationship between the host vehicle 10, which is making a lane change into the adjacent lane LN2 (second lane), and the other vehicle 500.

In the present embodiment, the travel ECU 38 (the approach suppression control unit) sets the operation target range 330 to a lateral side of the host vehicle 10 (see FIGS. 10 to 14). In accordance with this feature, it is possible to more appropriately grasp the positional relationship between the other vehicle 500 and the lateral side of the host vehicle 10.

In the present embodiment, the travel ECU 38 (the approach suppression control unit) sets, as the operation target range 330, the range between the lateral side of the host vehicle 10 and the far side lane marking LM2far (see FIGS. 10 to 14). In accordance with this feature, it is possible to more appropriately grasp the positional relationship between the other vehicle 500 and the lateral side of the host vehicle 10.

In the present embodiment, the travel ECU 38 (approach suppression control unit) treats as a monitoring target the other vehicle 500, which exhibits a behavior of making a lane change into the adjacent lane LN2 (the second lane) (step S14 of FIG. 4: YES), and determines the positional relationship thereof with the operation target range 330 (step S15). In accordance with this feature, positional relationships are not determined between all of the other vehicles 500 traveling in the third lane LN3 and the operation target range 330, but rather, only the positional relationship with the operation target range 330 of the other vehicle 500, which exhibits a behavior of approaching the adjacent lane LN2, is determined. Consequently, it is possible to reduce the computational load associated with determining the positional relationship between the other vehicle 500 and the operation target range 330. Along therewith, a configuration is facilitated in which determination of the positional relationship can be carried out with high accuracy.

According to the present embodiment, the travel assist device 12 includes the GPS sensor 40 (host vehicle information acquisition unit) which acquires the current position Pgps (position information Iphv) of the host vehicle 10 (see FIG. 1). When the distance d between the host vehicle 10 and the lane change reference position Plctar of the second lane LN2 becomes less than the second distance threshold value THd2 (step S35 of FIG. 15: NO), the travel ECU 38 (approach suppression control unit) does not perform the steering assist process (step S33) or the notification process (step S34). In other words, when the current position Pgps of the host vehicle 10 arrives at a reference position (a position where the distance d to the lane change reference position Plctar is less than the second distance threshold value THd2) in the widthwise direction of the adjacent lane LN2 (second lane), the ECU 38 limits suppression of the approach. In accordance with this feature, when the current position Pgps of the host vehicle 10 reaches the reference position, suppression of the approach between the host vehicle 10 and the other vehicle 500 (notification of the existence of the other vehicle 500, behavior control of the host vehicle 10 to suppress the approach, etc.) is not carried out. Consequently, for example, in a state in which the lane change has already been substantially completed, it is possible to avoid or reduce a feeling of unease or discomfort of the vehicle occupant accompanying suppression of the approach between the host vehicle 10 and the other vehicle 500.

In the present embodiment, the travel assist device 12 comprises the cameras 50 that capture images of the front and rear of the host vehicle 10 (see FIGS. 1 and 2). Further, the travel ECU 38 (approach suppression control unit) extracts one portion (e.g., the portion 310 shown in FIG. 5) of the far side lane marking LM2far of the adjacent lane LN2 (second lane) from the image information Iimage acquired by the cameras 50. Further, based on the position of the one portion, the ECU 38 calculates the position of the other portion (for example, the portion 312 shown in FIG. 5) of the far side lane marking LM2far that is not included within the image information Iimage (see FIG. 5). The ECU 38 can determine whether or not the other vehicle 500 is making a lane change into the adjacent lane LN2 on the basis of the calculated position of the other portion of the far side lane marking LM2far, and the position Pov of the other vehicle 500 (step S14 of FIG. 4, FIGS. 10 to 14). In accordance with this feature, it is possible to determine whether or not the other vehicle 500 is making a lane change into the adjacent lane LN2, even if the far side lane marking LM2far in the vicinity of the other vehicle 500 is not included within the field angle (angle of view) of the cameras 50.

According to the present embodiment, the travel ECU 38 (approach suppression control unit) further comprises the host vehicle predicted trajectory computation unit 208 (first trajectory acquisition unit) that acquires the predicted trajectory Lhve of the host vehicle 10, and the other vehicle predicted trajectory computation unit 210 (second trajectory acquisition unit) that acquires the predicted trajectory Love of the other vehicle 500 (FIG. 3). Furthermore, in the case it is determined on the basis of the predicted trajectories Lhve, Love of the host vehicle 10 and the other vehicle 500 that the possibility of contact Pc is high (stated otherwise, the host vehicle 10 and the other vehicle 500 have come into a predetermined state of approach) (step S16 of FIG. 4: YES), the ECU 38 suppresses the approach between the host vehicle 10 and the other vehicle 500 (step S17 of FIG. 4). In accordance with this feature, using the predicted trajectories Lhve, Love of the host vehicle 10 and the other vehicle 500, it is possible to highly accurately determine whether it is necessary or unnecessary to suppress the approach between the host vehicle 10 and the other vehicle 500.

In the present embodiment, in the case that another fourth lane LN4 (for example, the lane 402b shown in FIG. 9A) exists between the adjacent lane LN2 (second lane) and the third lane LN3 (step S23 of FIG. 7: NO), the travel ECU 38 (approach suppression control unit) does not carry out the steering assist process (step S33 of FIG. 15) or the notification process (step S34 of FIG. 15) (step S27 of FIG. 7, step S16 of FIG. 4: NO). Stated otherwise, the ECU 38 limits suppression of the approach. Owing to this feature, for example, in accordance with the predicted trajectory Love of the other vehicle 500, even if there is a possibility of determining that the other vehicle 500 is making a lane change into the adjacent lane LN2, if the other vehicle 500 makes a lane change into the fourth lane LN4 instead of the second lane LN2, it is possible to avoid or suppress excessive execution of the approach suppression control. Accordingly, it is possible to prevent the driver from experiencing a sense of discomfort accompanying an excessive approach suppression control.

### B. Modifications

The present invention is not limited to the embodiment described above, and various modified or additional configurations could be adopted therein based on the content of the present specification. For example, the following configurations can be adopted.

<B-1. Objects to which the Invention Can be Applied>

In the embodiment described above, it was assumed that the travel ECU 38 (travel control device) was used in a vehicle 10 such as an automobile (or car) (see FIG. 1). However, for example, from the standpoint of suppressing mutual approaching between the host vehicle 10, which is making a lane change from the first lane LN1 into the second lane LN2, and the other vehicle 500, which is making a lane change from the third lane LN3 into the second lane LN2, the invention is not limited to such an assumption. For example, the vehicle 10 (or conveyance) may be a moving object such as a ship, an aircraft, or the like. Alternatively, concerning the vehicle 10, other devices can also be used (for example, various manufacturing devices, or robots).

### <B-2. Configuration of Vehicle 10>

### [B-2-1. Navigation Device 20]

In the above-described embodiment, the current position Pgps of the vehicle 10 is acquired by the GPS sensor 40 (see FIG. 1). However, for example, from the standpoint of acquiring the current position Pgps of the vehicle 10, the present invention is not limited to this feature. For example, the navigation device 20 (or the vehicle 10) may acquire the current position Pgps from the other vehicle 500, or from a stationary device (a beacon or the like) on the side of the road.

### [B-2-2. Sensor Groups 22, 24, 26]

The vehicle peripheral sensor group 22 of the above-described embodiment includes the plurality of vehicle exterior cameras 50, and the plurality of radar devices 52 (see FIG. 1). However, for example, from the standpoint of suppressing mutual approaching between the host vehicle 10, which is making a lane change from the first lane LN1 into the second lane LN2, and the other vehicle 500, which is making a lane change from the third lane LN3 into the second lane LN2, the invention is not limited to such a feature.

For example, in the case that the plurality of vehicle exterior cameras 50 include a stereo camera adapted to detect the lateral sides of the vehicle 10, the radar devices 52 can be omitted. Alternatively, in addition to or in place of the vehicle exterior cameras 50 and the radar devices 52, a LIDAR (Light Detection And Ranging) system may be used. Such a LIDAR system continuously irradiates a laser in all directions of the vehicle 10, measures the three-dimensional position of reflection points based on the reflected waves, and outputs the measurements as three-dimensional information Ilidar.

The vehicle body behavior sensor group 24 according to the above-described embodiment includes the vehicle velocity sensor 60, the lateral acceleration sensor 62, and the yaw rate sensor 64 (see FIG. 1). However, for example, from the standpoint of suppressing mutual approaching between the host vehicle 10, which is making a lane change from the first lane LN1 into the second lane LN2, and the other vehicle 500, which is making a lane change from the third lane LN3 into the second lane LN2, the invention is not limited to such an assumption. For example, it is possible to eliminate one or more of the vehicle velocity sensor 60, the lateral acceleration sensor 62, or the yaw rate sensor 64.

The driving operation sensor group 26 according to the above-described embodiment includes the AP sensor 80, the BP sensor 82, the steering angle sensor 84, the steering torque sensor 86, and the blinker switch 88 (see FIG. 1). However, for example, from the standpoint of suppressing mutual approaching between the host vehicle 10, which is making a lane change from the first lane LN1 into the second lane LN2, and the other vehicle 500, which is making a lane change from the third lane LN3 into the second lane LN2, the invention is not limited to such an assumption. For example, it is possible for one or more of the AP sensor 80, the BP sensor 82, the steering angle sensor 84, the steering torque sensor 86, and the blinker switch 88 to be omitted.

### [B-2-3. Travel ECU 38]

In the above-described embodiment, the respective units shown in FIG. 3 (the lane information computation unit 200, the host vehicle lane change determining unit 202, etc.) are included in a single travel ECU 38. However, for example, from the standpoint of suppressing mutual approaching between the host vehicle 10, which is making a lane change from the first lane LN1 into the second lane LN2, and the other vehicle 500, which is making a lane change from the third lane LN3 into the second lane LN2, the invention is not limited to such an assumption. The respective units shown in FIG. 3 may be distributed over a plurality of electronic control units (ECUs).

### <B-3. Control by the Travel ECU 38>

### [B-3-1. Method of Changing Lanes]

In the embodiment described above, a case has been described in which the host vehicle 10 makes a lane change by the driver operating the steering wheel 94 (see FIG. 4). However, for example, from the standpoint of suppressing mutual approaching between the host vehicle 10, which is making a lane change from the first lane LN1 into the second lane LN2, and the other vehicle 500, which is making a lane change from the third lane LN3 into the second lane LN2, the invention is not limited to such an assumption. For example, the present invention can also be applied to a configuration in which a lane change is made automatically. Stated otherwise, it is possible for the present invention to be applied to automatic driving, which enables traveling without requiring driving operations performed by the driver.

### [B-3-2. Detection of Lane Markings LM]

In the above-described embodiment, the lane markings LM were detected based on the image information Iimage from the cameras 50 (step S12 of FIG. 4, FIG. 5). Further, concerning the portion (for example, the portion 312 shown in FIG. 5) not included within the imaging range Rcamera (angle of view) of the cameras 50, such a portion was estimated on the basis of the portion (for example, the portion 310 shown in FIG. 5) of the lane markings LM detected based on the image information Iimage (see FIG. 5). However, for example, from the standpoint of specifying the range of the lanes LN, the present invention is not limited to this feature. For example, although guard rails may exist, lines such as white lines or the like may not exist in certain cases. In such a situation, lane markings LM that serve as lane marking sectional lines may be set virtually based on the guard rails.

### [B-3-3. Detection of Other Vehicle 500]

In the above-described embodiment, the other vehicle 500 was detected using the radar information Iradar and the image information Iimage (step S13 of FIG. 4, FIG. 5). However, for example, from the standpoint of detecting the other vehicle 500, the present invention is not limited to this feature. For example, the other vehicle 500 may be detected using only one of the radar information Iradar or the image information Iimage. Moreover, in the case of detecting the other vehicle 500 using only the image information Iimage, the imaging range Rcamera of the cameras 50 must include the lateral sides of the host vehicle 10. Alternatively, a LIDAR system may be used instead of or in addition to the cameras 50 and/or the radar devices 52.

### [B-3-4. Determination of Lane Change by the Other Vehicle 500 (Step S14 of FIG. 4)]

According to the above-described embodiment, the start of the lane change by the other vehicle 500 was determined based on the velocity Vy of the other vehicle 500 in a direction (lateral direction) that is perpendicular to the lane LN (step S14 of FIG. 4, FIG. 6). However, for example, from the standpoint of determining the start of the lane change of the other vehicle 500, the present invention is not limited to this feature. For example, in addition to or instead of the velocity Vy of the other vehicle 500 in the lateral direction, the start of the lane change by the other vehicle 500 may be determined on the basis of the lateral acceleration of the other vehicle 500.

Alternatively, the start of the lane change by the other vehicle 500 can be determined on the basis of a positional relationship between the other vehicle 500 and the far side lane marking LM2far (for example, the distance between them). Alternatively, the start of the lane change by the other vehicle 500 can also be determined by way of communications (vehicle-to-vehicle communications) between the host vehicle 10 and the other vehicle 500. In this case, for example, the other vehicle 500 wirelessly transmits to the host vehicle 10 a signal indicative of the fact that the other vehicle 500 has started making a lane change, and on the basis of such a signal, the host vehicle 10 understands that the other vehicle 500 has started to make a lane change.

### [B-3-5. Possibility of Contact Pc (Steps S15, S16 of FIG. 4)]

### (B-3-5-1. Method of Use of Possibility of Contact Pc)

According to the above-described embodiment, in the case that the possibility of contact Pc is high (step S16 of FIG. 4: YES), the approach suppression control is executed (step S17), whereas in the case that the possibility of contact Pc is not high (step S16 of FIG. 4: NO), the approach suppression control is not executed. However, for example, from the standpoint of suppressing mutual approaching between the host vehicle 10, which is making a lane change from the first lane LN1 into the second lane LN2, and the other vehicle 500, which is making a lane change from the third lane LN3 into the second lane LN2, the invention is not limited to such an assumption. For example, in the case that the host vehicle 10 starts to make a lane change from the first lane LN1 into the second lane LN2 (step S11 of FIG. 4: YES), and the other vehicle 500 starts to make a lane change from the third lane LN3 into the second lane LN2 (step S14: YES), the approach suppression control may be started immediately.

(B-3-5-2. Predicted Trajectories Lhve, Love of the Host Vehicle 10 and the Other Vehicle 500 (steps S21, S22, S25 of FIG. 7))

In the above-described embodiment, the predicted trajectories Lhve, Love of the host vehicle 10 and the other vehicle 500, and the operation target range 330 were used to determine the possibility of contact Pc (see FIG. 7). However, for example, from the standpoint of determining whether or not to suppress mutual approaching between the host vehicle 10, which is making a lane change from the first lane LN1 into the second lane LN2, and the other vehicle 500, which is making a lane change from the third lane LN3 into the second lane LN2, the invention is not limited to such an assumption. For example, it also is possible to determine the possibility of contact Pc from a comparison between the operation target range 330 and the current position of the other vehicle 500, without using the predicted trajectory Love of the other vehicle 500.

(B-3-5-3. Operation Target Range 330 (steps S24, S25 of FIG. 7))

In the above-described embodiment, the operation target range 330 is used to determine whether or not the approach suppression control is required (steps S24, S25 of FIG. 7, FIGS. 10 to 14). However, for example, from the standpoint of determining whether or not to suppress mutual approaching between the host vehicle 10, which is making a lane change from the first lane LN1 into the second lane LN2, and the other vehicle 500, which is making a lane change from the third lane LN3 into the second lane LN2, the invention is not limited to such an assumption. For example, it is possible to determine the need for the approach suppression control, using a boundary line that does not define an area or a volume (stated otherwise, an operation target range 330 in which the area and volume thereof are not defined).

Alternatively, the necessity for the approach suppression control may be determined by a single threshold value (stated otherwise, the operation target range 330 defined by a single value) for the purpose of determining a positional relationship (for example, a distance at respective points in time or a time to collision (TTC)) between the predicted trajectory Lhve of the host vehicle and the predicted trajectory Love of the other vehicle. Moreover, the operation target range 330 and the boundary line can be regarded as a set including a plurality of threshold values.

### [B-3-6. Approach Suppression Control (Step S17 of FIG. 4)]

### (B-3-6-1: Method of Suppressing Approach Between Host Vehicle 10 and Other Vehicle 500)

In the approach suppression control of the above-described embodiment, the method indicated in FIG. 15 is used. However, for example, from the standpoint of suppressing the host vehicle 10 and the other vehicle 500 from approaching each other, the invention is not limited to this feature. For example, it also is possible to perform only one of the steering assist process (step S33) or the notification process (step S34) of FIG. 15.

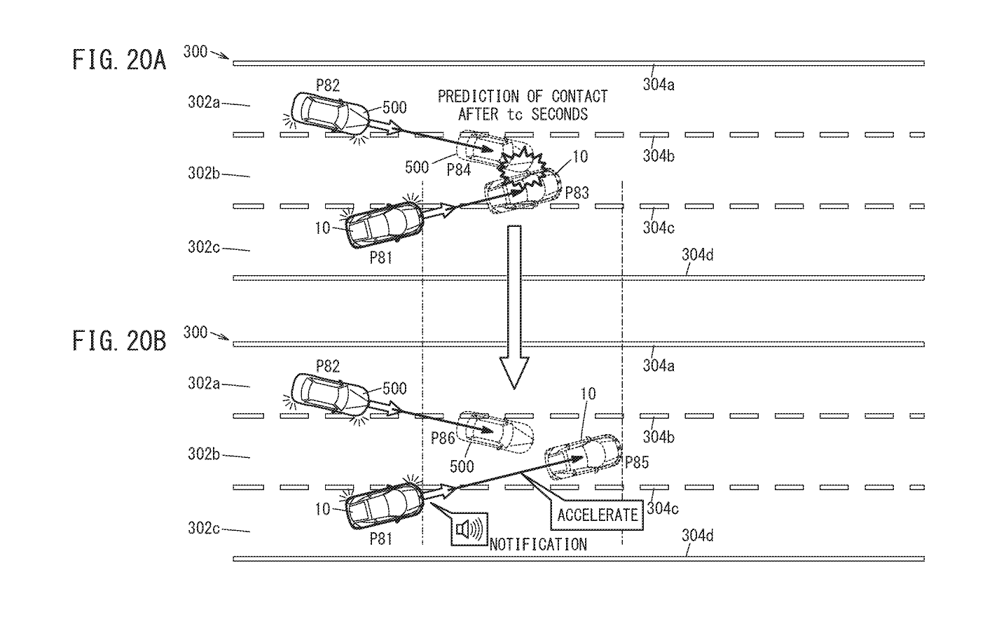

FIG. 19 is a flowchart of an approach suppression control according to a modified example. FIG. 20A is a diagram showing positions P81, P82 of the host vehicle 10 and the other vehicle 500 at a certain point in time (time t11), as well as positions P83, P84 of the host vehicle 10 and the other vehicle 500 estimated at the point in time t11. FIG. 20B is a diagram showing positions P81, P82 of the host vehicle 10 and the other vehicle 500 at the point in time t11, as well as positions P85, P86 of the host vehicle 10 and the other vehicle 500 as a result of causing the host vehicle 10 to accelerate by the approach suppression control according to the modified example.

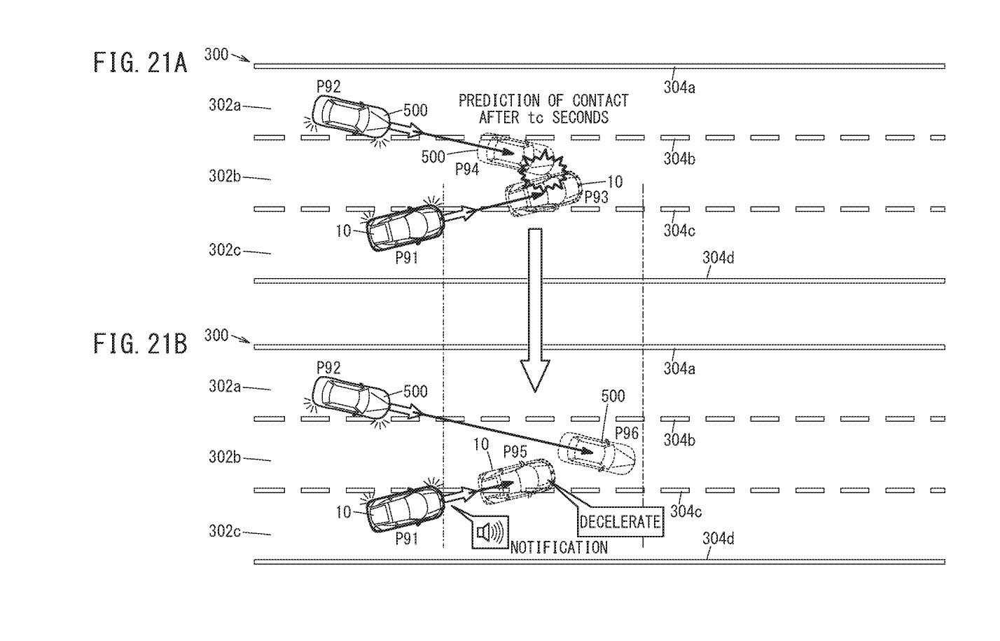

FIG. 21A is a diagram showing positions P91, P92 of the host vehicle 10 and the other vehicle 500 at a certain point in time (time t12), as well as positions P93, P94 of the host vehicle 10 and the other vehicle 500 estimated at the point in time t12. FIG. 21B is a diagram showing positions P91, P92 of the host vehicle 10 and the other vehicle 500 at the point in time t12, as well as positions P95, P96 of the host vehicle 10 and the other vehicle 500 as a result of causing the host vehicle 10 to decelerate by the approach suppression control according to the modified example. However, in FIG. 21B, acceleration is carried out in the other vehicle 500 by a driving operation of the driver of the other vehicle 500.

With the modified example shown in FIGS. 19 to 21B, acceleration and deceleration of the host vehicle 10 are performed using the acceleration/deceleration control unit 224 (see FIG. 3) of the ECU 38. As noted above, the acceleration/deceleration control unit 224 (acceleration/deceleration assist unit) controls the acceleration/deceleration process via the driving force control system 32 and the braking force control system 34. In the acceleration/deceleration process, the host vehicle 10 is automatically accelerated or decelerated by setting a target vehicle velocity. Alternatively, in the acceleration/deceleration process, the host vehicle 10 may be automatically accelerated or decelerated by setting a target vehicle acceleration or deceleration.

In step S51 of FIG. 19, the ECU 38 performs the same notification process as that of step S34 of FIG. 15 (position P81 of FIG. 20B and position P91 of FIG. 21B). In step S52, the ECU 38 determines whether or not the host vehicle 10 reaches the second lane LN2 in advance (or earlier). Such a determination is made on the basis of the predicted trajectories Lhve, Love of the host vehicle 10 and the other vehicle 500. Moreover, in step S52, it may be determined whether or not the distance by which the host vehicle 10 enters the adjacent lane LN2 (the entrance distance of the host vehicle 10) is greater than that of the other vehicle 500.

If it is determined that the host vehicle 10 will reach the second lane LN2 in advance (step S52: YES), then in step S53, the ECU 38 hastens the entry of the host vehicle 10 into the second lane LN2. For example, the ECU 38 accelerates the host vehicle 10 (refer to position P85 of FIG. 20B). Stated otherwise, the acceleration/deceleration control unit 224 implements an acceleration process as part of the acceleration/deceleration process. For example, the acceleration process can be performed by setting the target vehicle velocity (to a value higher than the current vehicle velocity V). Alternatively, in the acceleration process, the target longitudinal acceleration may be set (to a value higher than the current longitudinal acceleration). Alternatively, the ECU 38 need not necessarily carry out additional acceleration (acceleration process). Further, the ECU 38 may delay the arrival at the lane change reference position Plctar (see FIG. 16, etc.) by carrying out a steering assist process.

If it is determined that the host vehicle 10 will not reach the second lane LN2 in advance (step S52: NO), then in step S54, the ECU 38 delays the entry of the host vehicle 10 into the second lane LN2. For example, the ECU 38 decelerates the host vehicle 10 (refer to position P95 of FIG. 21B). Stated otherwise, the acceleration/deceleration control unit 224 implements a deceleration process as part of the acceleration/deceleration process. For example, the deceleration process can be performed by setting the target vehicle velocity (to a value lower than the current vehicle velocity V). Alternatively, in the deceleration process, the target longitudinal acceleration may be set (to a value lower than the current longitudinal acceleration). Alternatively, the ECU 38 may simply decrease the longitudinal acceleration of the host vehicle 10 without decelerating the host vehicle 10. Further, the ECU 38 may delay the arrival at the lane change reference position Plctar (see FIG. 16, etc.) by carrying out a steering assist process.

According to the modified example of FIG. 19, the travel assist device 12 includes the acceleration/deceleration control unit 224 (acceleration/deceleration assist unit) that automatically accelerates or decelerates the host vehicle 10 by setting a target vehicle velocity or a target acceleration/deceleration (see FIG. 3). In the approach suppression control, by changing the target vehicle velocity or the target acceleration/deceleration using the acceleration/deceleration control unit 224, the host vehicle 10 and the other vehicle 500 are prevented or suppressed from approaching each other (see FIGS. 20B, 21B). In accordance with this feature, it becomes easy to prevent the host vehicle 10 and the other vehicle 500 from approaching each other.

In the modified example of FIG. 19, in the case it is estimated that the other vehicle 500 will finish making a lane change into the adjacent lane LN2 (second lane) earlier than the host vehicle 10 (step S52 of FIG. 19: NO), the travel ECU 38 (approach suppression control unit) executes the approach suppression control in order to delay the entry of the host vehicle 10 into the second lane LN2 (step S54). In accordance with this feature, it becomes easy to prevent the host vehicle 10 and the other vehicle 500 from approaching each other.

In the modified example of FIG. 19, in the case it is estimated that the host vehicle 10 will finish making a lane change into the second lane LN2 earlier than the other vehicle 500 (step S52: YES), the travel ECU 38 (approach suppression control unit) executes the approach suppression control in order to hasten the entry of the host vehicle 10 into the second lane LN2, or limits the approach suppression control (step S53).

In the case that the approach suppression control is executed so as to hasten entry of the host vehicle 10 into the second lane LN2, it becomes easy to further prevent the host vehicle 10 and the other vehicle 500 from approaching each other. Further, in the case of limiting suppression of the approach between the host vehicle 10 and the other vehicle 500 (notification of the existence of the other vehicle 500, behavior control of the host vehicle 10 to suppress the approach, etc.), for example, it is possible to avoid or reduce a feeling of unease or discomfort of the vehicle occupant accompanying excessive suppression of the approach between the host vehicle 10 and the other vehicle 500.

### (B-3-6-2. Notification Process)

In the notification process of the above-described embodiment, a warning display on the meter display 110, output of a warning sound from the speaker 112, generation of vibrations by the vibration imparting device 114 provided in the lumbar support, and emission of light emitted by the door mirror indicator 116 are used (step S34 of FIG. 15). However, for example, from the standpoint of issuing a notification by way of human sensation that an approach between the host vehicle 10 and the other vehicle 500 should be suppressed, the present invention is not limited to such features. For example, any of the aforementioned notification methods may be omitted. Alternatively, in the notification process, it is also possible to perform the aforementioned notification through vibration or a reaction force applied to the steering wheel 94 or the accelerator pedal 90.

Further, for example, from the standpoint of suppressing mutual approaching between the host vehicle 10, which is making a lane change from the first lane LN1 into the second lane LN2, and the other vehicle 500, which is making a lane change from the third lane LN3 into the second lane LN2, it is also possible to omit the notification process of issuing a notification to the vehicle occupant. In this case, it is possible to perform a process (steps S53, S54 of FIG. 19) to carry out acceleration or deceleration of the host vehicle 10 automatically.

### <B-4. Other Considerations>

In the above-described embodiment, cases exist in which an equal sign is included or not included in the numerical comparisons (steps S32, S35 of FIG. 15, etc.). However, for example, if there is no special reason for including or excluding such an equal sign (or stated otherwise, for cases in which the effects of the present invention are obtained), it can be set arbitrarily as to whether to include an equal sign in the numerical comparisons.

As to what this implies, for example, the determination (d≧THd1) in step S32 of FIG. 15 as to whether or not the distance d is greater than or equal to the first distance threshold value THd1 can be changed to a determination as to whether or not the distance d is greater than the first distance threshold value THd1 (d>THd1).

While the invention has been particularly shown and described with reference to preferred embodiments, it will be understood that variations and modifications can be effected thereto by those skilled in the art without departing from the scope of the invention as defined by the appended claims.

### C. Explanation of Reference Numerals

10 . . . vehicle (host vehicle)
12 . . . travel assist device
14 . . . approach suppression operation unit
30 . . . HMI (notifying unit)
32 . . . driving force control system (behavior control unit)
34 . . . braking force control system (behavior control unit)
36 . . . EPS system (behavior control unit)
38 . . . travel ECU (approach suppression control unit)
40 . . . GPS sensor (host vehicle information acquisition unit)
50 . . . vehicle exterior cameras
200 . . . lane information computation unit (lane information acquisition unit)
204 . . . other vehicle recognition unit (other vehicle information acquisition unit)
208 . . . host vehicle predicted trajectory computation unit (first trajectory acquisition unit)
210 . . . other vehicle predicted trajectory computation unit (second trajectory acquisition unit)
224 . . . acceleration/deceleration control unit (acceleration/deceleration assist unit)
310 . . . one portion of far side lane marking
312 . . . other portion of far side lane marking
330 . . . operation target range
500 . . . other vehicle
Iimage . . . image information
Iphv . . . host vehicle position information
Iplm2far . . . far side lane marking position information
Ipln2 . . . second lane position information
Ipov . . . other vehicle position information
LM2far . . . far side lane marking
LM2near . . . near side lane marking
LN1 . . . first lane
LN2 . . . second lane
LN3 . . . third lane
LN4 . . . fourth lane
Lhve . . . host vehicle predicted trajectory
Love . . . other vehicle predicted trajectory
Pgps . . . host vehicle current position
Plctar . . . lane change reference position
Wln2 . . . second lane width

What is claimed is:

1. A travel assist device comprising:
an approach suppression control unit configured to monitor, when a host vehicle makes a lane change from a first lane into a second lane, whether or not another vehicle, which is traveling in a third lane existing on an opposite side from the first lane with the second lane interposed therebetween, is making a lane change into the second lane, and to execute an approach suppression control to prevent the host vehicle and the other vehicle from approaching each other, in a case it is determined that the other vehicle is making a lane change from the third lane into the second lane.

2. The travel assist device according to claim 1, wherein:
the travel assist device further comprises:
a lane information acquisition unit configured to acquire position information of the second lane;
an other vehicle information acquisition unit configured to acquire position information of the other vehicle; and
an approach suppression operation unit configured to perform an approach suppression operation to prevent the host vehicle and the other vehicle from approaching each other based on a command from the approach suppression control unit; and
the approach suppression operation unit comprises at least one of:
a notifying unit configured to notify a vehicle occupant of presence of the other vehicle; and
a behavior control unit configured to control behavior of the host vehicle, and thereby prevent the host vehicle and the other vehicle from approaching each other;
wherein the approach suppression control unit:
sets an operation target range configured to be used for carrying out the approach suppression operation by the approach suppression operation unit, based on position information of the host vehicle and the position information of the second lane; and
causes the approach suppression operation to be carried out by the approach suppression operation unit, in a case it is determined that the other vehicle has entered into the operation target range, or in a case it is estimated that the other vehicle will enter into the operation target range.

3. The travel assist device according to claim 2, wherein:
when, among two lane markings that define the second lane, a lane marking on a side of the first lane is defined as a near side lane marking, and a lane marking on a side of the third lane is defined as a far side lane marking;
the lane information acquisition unit acquires width information of the second lane indicative of a distance between the near side lane marking and the far side lane marking, or acquires position information of the far side lane marking; and
the approach suppression control unit sets the operation target range based on the width information of the second lane, or the position information of the far side lane marking.

4. The travel assist device according to claim 3, wherein the approach suppression control unit sets the operation target range to a lateral side of the host vehicle.

5. The travel assist device according to claim 3, wherein the approach suppression control unit sets as the operation target range a range between a lateral side of the host vehicle and the far side lane marking.

6. The travel assist device according to claim 2, wherein the approach suppression control unit treats as a monitoring target the other vehicle, which exhibits a behavior of making a lane change into the second lane, and determines a positional relationship thereof with the operation target range.

7. The travel assist device according to claim 1, wherein:
the travel assist device further comprises a host vehicle information acquisition unit configured to acquire position information of the host vehicle; and
if a current position of the host vehicle reaches a reference position in a widthwise direction of the second lane, the approach suppression control unit limits suppression of the approach.

8. The travel assist device according to claim 1, wherein:
the travel assist device further comprises a camera configured to capture an image of a front or rear of the host vehicle;
when, among two lane markings that define the second lane, a lane marking on a side of the first lane is defined as a near side lane marking, and a lane marking on a side of the third lane is defined as a far side lane marking;
the approach suppression control unit:
extracts one portion of the far side lane marking from image information from the camera;
calculates another portion of the far side lane marking, which is not included within the image information, on basis of a position of the one portion of the far side lane marking included within the image information; and
determines whether or not the other vehicle is making a lane change into the second lane on basis of a calculated position of the other portion of the far side lane marking, and a position of the other vehicle.

9. The travel assist device according to claim 1, wherein:
the approach suppression control unit comprises:
a first trajectory acquisition unit configured to acquire a predicted trajectory of the host vehicle; and
a second trajectory acquisition unit configured to acquire a predicted trajectory of the other vehicle;
wherein, in a case it is determined on basis of the predicted trajectories of the host vehicle and the other vehicle that the host vehicle and the other vehicle come into a predetermined state of approach, the approach suppression control unit suppresses approach between the host vehicle and the other vehicle.

10. The travel assist device according to claim 1, wherein, in a case that another fourth lane exists between the second lane and the third lane, the approach suppression control unit limits suppression of the approach.

11. The travel assist device according to claim 1, wherein:
the travel assist device further comprises an acceleration/deceleration assist unit configured to automatically accelerate or decelerate the host vehicle by setting a target vehicle velocity or a target acceleration/deceleration; and
in the approach suppression control, mutual approaching between the host vehicle and the other vehicle is suppressed by changing the target vehicle velocity or the target acceleration/deceleration by the acceleration/deceleration assist unit.

12. The travel assist device according to claim 1, wherein, in a case it is estimated that the other vehicle will complete making a lane change into the second lane earlier than the host vehicle, or in a case that an entrance distance of the other vehicle into the second lane is greater than that of the host vehicle, the approach suppression control unit executes the approach suppression control so as to delay entry of the host vehicle with respect to the second lane.

13. The travel assist device according to claim 1, wherein, in a case it is estimated that the host vehicle will complete making a lane change into the second lane earlier than the other vehicle, or in a case that an entrance distance of the host vehicle into the second lane is greater than that of the other vehicle, the approach suppression control unit executes the approach suppression control so as to hasten entry of the host vehicle with respect to the second lane or limits the approach suppression control.

14. A travel assist method, comprising the steps of:
when a host vehicle makes a lane change from a first lane into a second lane, determining with an approach suppression control unit whether or not another vehicle, which is traveling in a third lane existing on an opposite side from the first lane with the second lane interposed therebetween, is making a lane change into the second lane; and
executing, with the approach suppression control unit, an approach suppression control to prevent the host vehicle and the other vehicle from approaching each other, in a case it is determined that the other vehicle is making a lane change from the third lane into the second lane.
